(19) United States
(12) Patent Application Publication
(10) Pub. No.: US 2007/0104050 A1
(43) Pub. Date: May 10, 2007

(54) Focus control device and tracking control device

(75) Inventor: Eiji Ueda, Yawata-shi (JP)

Correspondence Address: HAMRE, SCHUMANN, MUELLER & LARSON P.C., P.O. BOX 2902-0902, MINNEAPOLIS, MN, 55402, US

(73) Assignee: Matsushita Electric Industrial Co., Ltd, Osaka (JP)

(21) Appl. No.: 10/561,533

(22) PCT Filed: Jun. 24, 2004
(86) PCT No.: PCT/JP04/09270

§ 371 Date: Dec. 20, 2005

(30) Foreign Application Priority Data
Jun. 25, 2003 (JP) 2003-181695
Dec. 9, 2003 (JP) 2003-410593

(51) Int. Cl. G11B 7/00

(52) U.S. Cl. 369/44.35

(57) ABSTRACT

There is provided a focus control device including sensor means (101); error signal synthesizing means (102); arithmetic means (103) having an error input portion (104), a disturbance addition portion for adding a first disturbance value group to a focus error value group generated by the error input portion and producing an output, a phase compensation portion for performing at least a phase compensation calculation and an amplification calculation according to an amplification calculation gain on the output of the disturbance addition portion and generating a drive value group, a drive output portion (106) for generating a drive signal based on the drive value group, a response detection portion for detecting a detection complex amplitude value based on the focus error value group, a second disturbance value group, a second disturbance value group, and a third disturbance value group, and a gain modification portion for modifying the amplification calculation gain; driving means (108); and a focus actuator (109). The amplification calculation gain in the gain modification portion is modified based on the detection complex amplitude value, a predetermined complex amplitude value, and a correction complex value, and the phase of the correction complex value is substantially identical to the phase of the first disturbance value group.

### TECHNICAL FIELD

The present invention relates to focus control devices and tracking control devices that are used in optical disk devices for recording and reproducing information on and from optical disks using laser beams such as from semiconductor lasers.

### BACKGROUND ART

In general, focus control devices and tracking control devices that are used in optical disk devices are important in recording or reproducing information on or from an optical disk. In such a focus control device, the displacement between the recording surface of the optical disk and the focal point of the outgoing beam has to be controlled with high accuracy to, for example, within a range of ±0.5 micrometers (μm) so that recording and reproduction can be performed precisely even when the optical disk moves or the optical disk device vibrates. For this purpose, it is necessary to adapt the loop gain characteristics of the focus control device to desired characteristics at all times. In a tracking control device, the displacement between the track on the optical disk and the beam spot has to be controlled with high accuracy to, for example, within a range of ±10.1 micrometers (μm) so that recording and reproduction can be performed precisely even when the track on the optical disk is eccentric, for example. For this purpose, it is necessary to adapt the loop gain characteristics of the tracking control device to desired characteristics at all times.

However, there have been issues in that it is difficult to maintain the desired loop gain characteristics because of variations in the sensitivity for detecting focus error signals and tracking error signals, or the sensitivity of a focus actuator and a tracking actuator, and also due to temperature changes and changes due to aging.

With respect to such issues, a technique is disclosed in that the loop gain characteristics are adjusted by using an optical recording and reproducing device that is provided with control error signal detection means for detecting a displacement between a micro spot of a light beam and the position of a control target; servo means for moving the micro spot of the light beam to the position of the control target and holding the micro spot there; disturbance signal producing means for applying a disturbance signal to a servo loop; means for detecting a complex amplitude of a signal that responds to the disturbance signal applied to the servo loop; calculation means for detecting phase-gain characteristics of the servo loop from a previously stored complex amplitude value of the disturbance signal applied to the servo loop, based on an output of the complex amplitude detection means; and adjustment means for changing the phase-loop characteristics of the servo loop in accordance with an output of the calculation means (e.g., see JP H4-49530A). In this technique, the phase-gain characteristics of the servo loop are adjusted to desired characteristics by detecting the complex amplitude of the signal that responds to the disturbance signal applied to the servo loop, and changing the phase-gain characteristics of the servo loop in accordance with that complex amplitude and the complex amplitude value of the disturbance signal applied to the servo loop, which has been stored in advance. When this technique is employed, the gain-phase characteristics of the servo loop can be determined at a high speed with high accuracy using a circuit structure having a small number of elements; and furthermore, the characteristics of the servo loop can be set to a predetermined value by adjusting the gain-phase characteristics of the servo loop, and thus, stable servo characteristics can be achieved.

However, it was found that in the above-described technique, depending on the value of a predetermined complex amplitude value that has been stored in advance (here, “value” means the phase and amplitude of the predetermined complex amplitude value), an error can occur in adjusting the servo loop characteristics of the focus control device and the tracking control device. In particular, it was found that when the disturbance signal producing means is configured such that a disturbance value group that has been stored by dividing the time of a single cycle of a periodic function (sine function) into N equal parts is added sequentially, the smaller the division number N is, the greater the adjustment error becomes. Moreover, when an increase in the band of the servo loop characteristics is required in order to increase the density or the vibration resistance of the optical disks, the frequency of the periodic function increases, and thus, when assuming that the frequency at which the disturbance value group is added by the disturbance signal producing means is unchanged, the division number N is reduced substantially. Furthermore, also when the operating speed of the calculation means is slowed down in order to save electric power, this division number N has to be reduced. Consequently, the adjustment error increases. Thus, in the future, promotion of an increase in the density or the vibration resistance of the optical disks, or of electric power savings in equipment may lead to an increase in adjustment errors of the servo loop characteristics in the focus control device and the tracking control device.

### DISCLOSURE OF INVENTION

It is an object of the present invention to provide a focus control device and a tracking control device that are capable of adjusting a gain of a focus servo system and a gain of a tracking servo system accurately and making an adjustment accurately so that desired loop gain characteristics can be achieved.

The focus control device according to the present invention is a focus control device including sensor means for receiving light reflected from an optical disk and outputting a plurality of sensor signals; error signal synthesizing means for arithmetically synthesizing the plurality of sensor signals and generating a focus error signal; arithmetic means including an error input portion for generating a focus error value group based on the focus error signal, a disturbance addition portion for adding a first disturbance value group that has periodicity to the focus error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the focus error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain; driving means for outputting a driving current that is approximately proportional to the drive signal; and a focus actuator for driving an objective lens according to the driving current, wherein the gain modification portion modifies the amplification calculation gain based on the detection complex amplitude value, a predetermined complex amplitude value, and a correction complex value for correcting the predetermined complex amplitude value, and wherein a phase of the correction complex value is substantially identical to a phase of the first disturbance value group in the disturbance addition portion. Hereinafter, the focus control device having this configuration also is referred to as a first focus control device.

Moreover, the focus control device according to the present invention is a focus control device including sensor means for receiving light reflected from an optical disk and outputting a plurality of sensor signals; error signal synthesizing means for arithmetically synthesizing the plurality of sensor signals and generating a focus error signal; arithmetic means including an error input portion for generating a focus error value group based on the focus error signal, a disturbance addition portion for adding a first disturbance value group that has periodicity to the focus error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the focus error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain based on the detection complex amplitude value and a predetermined complex amplitude value; driving means for outputting a driving current that is approximately proportional to the drive signal; and a focus actuator for driving an objective lens according to the driving current, wherein the gain modification portion modifies the amplification calculation gain based on the detection complex amplitude value, the predetermined complex amplitude value, and a correction complex value for correcting the detection complex amplitude value, and wherein a phase of the correction complex value is substantially identical to an antiphase of the first disturbance value group in the disturbance addition portion. Hereinafter, the focus control device having this configuration also is referred to as a second focus control device.

The tracking control device according to the present invention is a tracking control device including sensor means for receiving light reflected from an optical disk and outputting a plurality of sensor signals; error signal synthesizing means for arithmetically synthesizing the plurality of sensor signals and generating a tracking error signal; arithmetic means including an error input portion for generating a tracking error value group based on the tracking error signal, a disturbance addition portion for adding a first disturbance value group that has periodicity to the tracking error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the tracking error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain; driving means for outputting a driving current that is approximately proportional to the drive signal; and a tracking actuator for driving an objective lens according to the driving current, wherein the gain modification portion modifies the amplification calculation gain based on the detection complex amplitude value, a predetermined complex amplitude value, and a correction complex value for correcting the predetermined complex amplitude value, and wherein a phase of the correction complex value is substantially identical to a phase of the first disturbance value group in the disturbance addition portion. Hereinafter, the tracking control device having this configuration is also referred to as a first tracking control device.

Moreover, the tracking control device according to the present invention is a tracking control device including sensor means for receiving light reflected from an optical disk and outputting a plurality of sensor signals; error signal synthesizing means for arithmetically synthesizing the plurality of sensor signals and generating a tracking error signal; arithmetic means including an error input portion for generating a tracking error value group based on the tracking error signal, a disturbance addition portion for adding a first disturbance value group that has periodicity to the tracking error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the tracking error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain; driving means for outputting a driving current that is approximately proportional to the drive signal; and a tracking actuator for driving an objective lens according to the driving current, wherein the gain modification portion modifies the amplification calculation gain based on the detection complex amplitude value, a predetermined complex amplitude value, and a correction complex value for correcting the detection complex amplitude value, and wherein a phase of the correction complex value is substantially identical to an antiphase of the first disturbance value group in the disturbance addition portion. Hereinafter, the tracking control device having this configuration is also referred to as a second tracking control device.

### BRIEF DESCRIPTION OF DRAWINGS

FIG. 1 is a block diagram showing a configuration of a focus control device according to the embodiment 1.

FIG. 2 is a block diagram showing a configuration of a calculator that is provided for the focus control device according to the embodiment 1.

FIG. 3 is a flowchart showing an operation of the focus control device according to the embodiment 1.

FIG. 4 is a block diagram of a focus servo system for describing an operation of a gain modifier that is provided in the calculator of the focus control device according to the embodiment 1.

FIG. 5 is a graph for describing the operation of the gain modifier that is provided in the calculator of the focus control device according to the embodiment 1.

FIG. 6 is a block diagram showing a configuration of a tracking control device of the present embodiment.

FIG. 7 is a block diagram showing a configuration of a calculator that is provided in the tracking control device according to the embodiment 4.

FIG. 8 is a flowchart showing an operation of the tracking control device according to the embodiment 4.

FIG. 9 is a block diagram of a tracking servo system for describing an operation of a gain modifier that is provided in the calculator of the tracking control device according to the embodiment 4.

FIG. 10 is a graph for describing the operation of the gain modifier that is provided in the calculator of the tracking control device according to the embodiment 4.

### BEST MODE FOR CARRYING OUT THE INVENTION

The focus control device according to the present invention includes optical sensor means, error signal synthesizing means, arithmetic means, driving means, and a focus actuator, as described above. The arithmetic means further has an error input portion, a disturbance addition portion, a phase compensation portion, a drive output portion, a response detection portion, and a gain modification portion. The arithmetic means, except for the gain modification portion, may have any known configuration.

The error input portion generates a focus error value group based on a focus error signal generated by the optical sensor means and the error signal synthesizing means. The focus error value group can be generated, for example, by sampling the focus error signal at predetermined time intervals. Sampling usually is performed at predetermined intervals.

The disturbance addition portion adds a first disturbance value group that has periodicity to the focus error value group that is generated by the error input portion and produces an output. The first disturbance value group, which has periodicity, is conceptually identical to a numerical value group that represents function values that are generated by sampling a predetermined periodic function at predetermined time intervals and that have a staircase pattern. Hereinafter, the above-mentioned periodic function is abbreviated to “disturbance generating function”. Adding the focus error value group and the first disturbance value group means generating a disturbance-added error value group by sequentially adding one each of focus error values constituting the focus error value group and disturbance values constituting the first disturbance value group that are temporally synchronized with each other.

The phase compensation group performs at least a phase compensation calculation and an amplification calculation according to an amplification calculation gain on the output of the disturbance addition portion and generates a drive value group. More specifically, drive values are generated sequentially in such a manner that one drive value is generated for one focus error value. It should be noted that the amplification calculation gain is determined by the response detection portion and the gain modification portion.

The drive output portion generates a drive signal based on the drive value group that is generated by the phase compensation portion and outputs the drive signal to the driving means.

The response detection portion detects a detection complex amplitude value based on the focus error value group that is generated by the error input portion, a second disturbance value group that has the same periodicity as the first disturbance value group, and a third disturbance value group that has the same periodicity as the second disturbance value group and a phase that is shifted from the phase of the second disturbance value group. The second disturbance value group that has periodicity and the third disturbance value group that has periodicity are defined in the same way as in the case of the above-mentioned first disturbance value group. Having the same periodicity as the first disturbance value group means having a cycle that is identical to the cycle of the first disturbance value group. The amplitudes and the phases of the second disturbance value group and the third disturbance value group may differ from those of the first disturbance value group.

Here, the amplitudes and the phases of the first to third disturbance value groups will be described. The amplitude of a disturbance value group, such as the first to third disturbance value groups, is obtained from the amplitude of the disturbance generating function and a transfer function that performs sampling and zero-order holding on the disturbance generating function. The phase of a disturbance value group, such as the first to third disturbance value groups, is obtained from the phase of the disturbance generating function and the transfer function that performs sampling and zero-order holding on the disturbance generating function. In the present specification, the phases of the first to third disturbance value groups mean phase differences from a reference phase (phase: 0), which is the phase of the disturbance generating function relative to the first disturbance value group; and when a phase leads the disturbance generating function, it is taken as positive, while when a phase is delayed from the disturbance generating function, it is taken as negative. It should be noted that the amplitude and the phase of a disturbance value group differ from the amplitude and the phase of the disturbance generating function respectively. Moreover, the longer the sampling time interval is (the smaller the division number is), the larger the amplitude difference and the phase difference between the disturbance generating function and the transfer function become.

The gain modification portion modifies the amplitude calculation gain based on the detection complex amplitude value, a predetermined complex amplitude value, and a correction complex value. In the first focus control device, the predetermined complex amplitude value is corrected using a complex value having a phase that is substantially identical to the phase of the first disturbance value group as the correction complex value. Thus, the difference between the phase of the disturbance generating function and the phase of the first disturbance value group can be corrected, and the amplification calculation gain that is referenced by the phase compensation portion can be adjusted with higher accuracy than was previously possible. In particular, if the division number is small, then the phase difference between the disturbance generating function and the first disturbance value group increases, and thus the effect increases even more. It should be noted that the predetermined complex amplitude value in the first focus control device can be identical to a value that has been used in a conventional focus control device.

In the present specification, the phase of a complex value, such as the detection complex amplitude value, the predetermined complex amplitude value, and the correction complex value, means the angle on the complex plane formed by the positive real axis and a straight line joining the origin and a point corresponding to that complex value. An angle of rotation from the positive real axis in the direction of the positive imaginary axis is taken as positive, while an angle of rotation from the positive real axis in the direction of the negative imaginary axis is taken as negative. Moreover, in the present specification, being substantially identical to the phase of the first disturbance value group means that the correction complex value is not intentionally made to be out of phase with the first disturbance value group, and includes the case where the correction complex value is not exactly in phase with the first disturbance value group due to a calculation error, a production error, or the like.

Moreover, the gain modification portion in the second focus control device corrects the detection complex amplitude value using a complex value, as a correction complex value, that is substantially in antiphase with the first disturbance value group. “Antiphase” means that the positive and negative sides of a phase are reversed. That is to say, the correction complex value in the first focus control device and the correction complex value in the second focus control device are conjugate complex numbers. Thus, the difference between the phase of the disturbance generating function and the phase of the first disturbance value group can be corrected, and the amplification calculation gain that is referenced by the phase compensation portion can be adjusted with higher accuracy than was previously possible. It should be noted that the predetermined complex amplitude value in the second focus control device can be identical to a value that has been used in a conventional focus control device. In particular, if the division number is small, then the phase difference between the disturbance generating function and the first disturbance value group increases, and thus the effect increases even more.

Here, a brief explanation is provided regarding the fact that the gain of a focus servo system and the amplification calculation gain can be adjusted with higher accuracy than was previously possible. Usually, the initial setting value of the amplification calculation gain is determined so that it is optimized for the case where the optical disk is placed according to a setting and the phases of the first to third disturbance value groups are assumed to be identical to the phase of the disturbance generating function (analog signal). The gain of the focus servo system is equivalent to the gain of the open-loop transfer function of that system. Moreover, the detection complex amplitude value that is detected by the response detection portion changes in accordance with a change in the gain of the open-loop transfer function of the focus servo system.

Therefore, in the first and the second focus control devices, the gain of the focus servo system can be adjusted with high accuracy by giving consideration to the phase difference (the phase of the correction complex number) between the disturbance generating function that corresponds to the first disturbance value group and the first disturbance value group. Furthermore, since the gain of the focus servo system can be adjusted with high accuracy, the amplification calculation gain that is referenced by the phase compensation portion can be adjusted with high accuracy. It should be noted that in conventional focus control devices, no consideration is given to the phase difference between the disturbance generating function that corresponds to the first disturbance value group and the first disturbance value group (transfer function).

In the first focus control device according to the present invention, it is preferable that when the detection complex amplitude value is α, the predetermined complex amplitude value is β, and the correction complex value is γ, the gain modification portion modifies the amplification calculation gain based on the value of |α/(α+β×γ)|. This is because the gain of the open-loop transfer function of the focus servo system can be adjusted precisely according to this value. It should be noted that if the final value is equal to |α/(α+β×γ)|, any method can be employed to perform the calculation, as long as the predetermined complex amplitude value is multiplied by the correction complex value.

In the first focus control device according to the present invention, it is preferable that a numerical value group constituting a single cycle of the first disturbance value group is constituted by N disturbance values that are obtained by substantially equally dividing the time period of the single cycle, that the phase of the correction complex value is substantially −2π/N/2, and that the phase of the predetermined complex amplitude value is substantially 0. This is because the phase difference between the disturbance generating function that corresponds to the first disturbance value group and the first disturbance value group becomes −2π/N/2. The expression that the numerical value group constituting a single cycle of the first disturbance value group is constituted by N disturbance values is synonymous with the expression that the division number is N. It should be noted that in the present specification, being substantially −2π/N/2 means that the predetermined complex amplitude value is not intentionally made to be different from −2π/N/2, and includes the case where the predetermined complex amplitude value is not exactly −2π/N/2 due to a calculation error, a production error, or the like. Hereinafter, an expression that a phase is substantially a predetermined numerical value has the same meaning as described above.

In the first focus control device according to the present invention, it is preferable that the phase of the correction complex value is substantially −2π/N/2, and that when the frequency of the first disturbance value group is fm and the processing time at the arithmetic means for generating the drive signal from the focus error signal is Td, the phase of the predetermined complex amplitude value is −2π×fm×Td. The reason for this is that since the phase shift due to the processing time at the arithmetic processing means is −2π×fm×Td, a change in the gain of the focus servo system that is dependent on the processing time at the arithmetic means can be inhibited.

In the second focus control device according to the present invention, it is preferable that when the detection complex amplitude value is α, the predetermined complex amplitude value is β, and the correction complex value is γ, the gain modification portion modifies the amplification calculation gain based on the value of |α×γ/(α×γ+β)|. This is because the gain of the open-loop transfer function of the focus servo system can be adjusted precisely according to this value. It should be noted that if the final value is equal to |α×γ/(α×γ+β)|, any method can be employed to perform the calculation, as long as the detection complex amplitude value is multiplied by the correction complex value.

In the second focus control device according to the present invention, it is preferable that a numerical value group constituting a single cycle of the first disturbance value group is constituted by N disturbance values that are obtained by substantially equally dividing the time period of the single cycle, that the phase of the correction complex value is substantially 2π/N/2, and that the phase of the predetermined complex amplitude value is substantially 0. This is because the phase difference between the disturbance generating function that corresponds to the first disturbance value group and the first disturbance value group becomes −2π/N/2.

In the second focus control device according to the present invention, it is preferable that the phase of the correction complex value is substantially 2π/N/2, and that when the frequency of the first disturbance value group is fm and the processing time at the arithmetic means for generating the drive signal from the focus error signal is Td, the phase of the predetermined complex amplitude value is substantially 2π×fm×Td. A change in the gain of the focus servo system that is dependent on the processing time at the arithmetic means can be inhibited.

In the first and the second focus control devices according to the present invention, it is preferable that a numerical value group constituting a single cycle of the first disturbance value group is constituted by N disturbance values that are obtained through a substantially equal division in terms of time, and that the focus control devices further include a storage portion for storing the N disturbance values. In the disturbance addition portion, because the first disturbance value group has periodicity, values that are identical between cycles can be used as disturbance values. Therefore, if the storage portion is provided and the N disturbance values are stored in that portion, any disturbance value can be extracted from the storage portion. Thus, processing can be performed at a higher speed than in the case where each of the disturbance values is calculated through a calculation. In the present specification, dividing substantially equally means that an unequal division is not intentionally performed, and includes the case where an exactly equal division is not performed due to a calculation error, a production error, or the like.

In the first and the second focus control devices according to the present invention, it is preferable that the phase of the second disturbance value group is substantially identical to the phase of the first disturbance value group, and that the phase of the third disturbance value group is shifted from the phase of the second disturbance value group substantially by π/2. This is because the detection complex amplitude value can be detected precisely. In the present specification, being shifted substantially by π/2 means that the phase difference is not intentionally set to a value other than π/2, and includes the case where the phase difference is not exactly π/2 due to a calculation error, a production error, or the like.

In the first and the second focus control devices according to the present invention, it is preferable that the response detection portion detects the detection complex amplitude value based on a plurality of focus error values that are input during a period of time that is an integral multiple of the cycle of the first disturbance value group. This is because a measurement error of the detection complex amplitude value can be reduced. In particular, when the number of numerical values constituting a single cycle of the first disturbance value group is small (when the division number is small), the effect increases.

In the first and the second focus control devices according to the present invention, it is preferable that a numerical value group constituting a single cycle of the first disturbance value group is constituted by disturbance values, the number of which is an integral multiple of 4, that are obtained by substantially equally dividing the time period of the single cycle.

The tracking control device according to the present invention includes optical sensor means, error signal synthesizing means, arithmetic means, driving means, and a tracking actuator, as described above. The arithmetic means further has an error input portion, a disturbance addition portion, a phase compensation portion, a drive output portion, a response detection portion, and a gain modification portion. The arithmetic means, except for the gain modification portion, may have any known configuration.

The error input portion generates a tracking error value group based on a tracking error signal generated by the optical sensor means and the error signal synthesizing means. The tracking error value group can be generated, for example, by sampling the tracking error signal at predetermined time intervals and applying zero-order holding to a sampled value over the sampling time interval. Sampling usually is performed at predetermined intervals.

The disturbance addition portion adds a first disturbance value group that has periodicity to the tracking error value group that is generated by the error input portion and produces an output. Adding the tracking error value group and the first disturbance value group means generating a disturbance-added error value group by sequentially adding one each of tracking error values constituting the tracking error value group and disturbance values constituting the first disturbance value group that are temporally synchronized with each other.

The phase compensation group performs at least a phase compensation calculation and an amplification calculation according to an amplification calculation gain on the output of the disturbance addition portion and generates a drive value group. More specifically, drive values are generated sequentially in such a manner that one drive value is generated for one tracking error value. It should be noted that the amplification calculation gain is determined by the response detection portion and the gain modification portion.

The drive output portion generates a drive signal based on the drive value group that is generated by the phase compensation portion and outputs the drive signal to the driving means.

The response detection portion detects a detection complex amplitude value based on the tracking error value group that is generated by the error input portion, a second disturbance value group that has the same periodicity as the first disturbance value group, and a third disturbance value group that has the same periodicity as the second disturbance value group and a phase that is shifted from the phase of the second disturbance value group.

The gain modification portion modifies the amplitude calculation gain based on the detection complex amplitude value, a predetermined complex amplitude value, and a correction complex value. In the first tracking control device, the predetermined complex amplitude value is corrected using a complex value having a phase that is substantially identical to the phase of the first disturbance value group as the correction complex value. Thus, the difference between the phase of the disturbance generating function and the phase of the first disturbance value group can be corrected, and the amplification calculation gain that is referenced by the phase compensation portion can be adjusted with higher accuracy than was previously possible. In particular, if the division number is small, then the phase difference between the disturbance generating function and the first disturbance value group increases, and thus the effect increases even more. It should be noted that the predetermined complex amplitude value in the first tracking control device can be identical to a value that has been used in a conventional tracking control device.

Moreover, the gain modification portion in the second tracking control device corrects the detection complex amplitude value using a complex value, as a correction complex value, that is substantially in antiphase with the first disturbance value group. “Antiphase” means that the positive and negative sides of a phase are reversed. That is to say, the correction complex value in the first tracking control device and the correction complex value in the second tracking control device are conjugate complex numbers. Thus, the difference between the phase of the disturbance generating function and the phase of the first disturbance value group can be corrected, and the amplification calculation gain that is referenced by the phase compensation portion can be adjusted with higher accuracy than was previously possible. It should be noted that the predetermined complex amplitude value in the second tracking control device can be identical to a value that has been used in a conventional tracking control device. In particular, if the division number is small, then the phase difference between the disturbance generating function and the first disturbance value group increases, and thus the effect increases even more.

Here, a brief explanation is provided regarding the fact that the gain of a tracking servo system and the amplification calculation gain can be adjusted with higher accuracy than was previously possible. Usually, the initial setting value of the amplification calculation gain is determined so that it is optimized for the case where the optical disk is placed according to a setting and the phases of the first to third disturbance value groups are assumed to be identical to the phase of the disturbance generating function (analog signal). The gain of the tracking servo system changes in accordance with the gain of the open-loop transfer function of that system. Moreover, the gain of the open-loop transfer function of the tracking control device changes in accordance with the detection complex amplitude value that is detected by the response detection portion and the phase difference between the disturbance generating function and the first disturbance value group.

Therefore, in the first and the second tracking control devices, the gain of the tracking servo system can be adjusted with high accuracy by giving consideration to the phase difference (the phase of the correction complex number) between the disturbance generating function that corresponds to the first disturbance value group and the first disturbance value group. Furthermore, since the gain of the tracking servo system can be adjusted with high accuracy, the amplification calculation gain that is referenced by the phase compensation portion can be adjusted with high accuracy. It should be noted that in conventional tracking control devices, no consideration is given to the phase difference between the disturbance generating function that corresponds to the first disturbance value group and the first disturbance value group.

In the first tracking control device according to the present invention, it is preferable that when the detection complex amplitude value is α, the predetermined complex amplitude value is β, and the correction complex value is γ, the gain modification portion modifies the amplification calculation gain based on the value of |α(α+β×γ)|. This is because the gain of the open-loop transfer function of the tracking servo system can be adjusted precisely according to this value. It should be noted that if the final value is equal to |α/(α+β×γ)|, any method can be employed to perform the calculation, as long as the predetermined complex amplitude value is multiplied by the correction complex value.

In the first tracking control device according to the present invention, it is preferable that a numerical value group constituting a single cycle of the first disturbance value group is constituted by N disturbance values that are obtained by substantially equally dividing the time period of the single cycle, that the phase of the correction complex value is substantially −2π/N/2, and that the phase of the predetermined complex amplitude value is substantially 0. This is because the phase difference between the disturbance generating function that corresponds to the first disturbance value group and the first disturbance value group becomes −2π/N/2. The expression that the numerical value group constituting a single cycle of the first disturbance value group is constituted by N disturbance values is synonymous with the expression that the division number is N. It should be noted that in the present specification, being substantially −2π/2 means that the predetermined complex amplitude value is not intentionally made to be different from −2π/N/2, and includes the case where the predetermined complex amplitude value is not exactly −2π/N/2 due to a calculation error, a production error, or the like. Hereinafter, an expression that a phase is substantially a predetermined numerical value has the same meaning as described above.

In the first tracking control device according to the present invention, it is preferable that the phase of the correction complex value is substantially −2π/N/2, and that when the frequency of the first disturbance value group is fm and the processing time at the arithmetic means for generating the drive signal from the tracking error signal is Td, the phase of the predetermined complex amplitude value is −2π×fm×Td. The reason for this is that since the phase shift due to the processing time at the arithmetic processing means is −2π×fm×Td, a change in the gain of the tracking servo system that is dependent on the processing time at the arithmetic means can be inhibited.

In the second tracking control device according to the present invention, it is preferable that when the detection complex amplitude value is α, the predetermined complex amplitude value is β, and the correction complex value is γ, the gain modification portion modifies the amplification calculation gain based on the value of |α×γ/(α×γ+β)|This is because the gain of the open-loop transfer function of the tracking servo system can be adjusted precisely according to this value. It should be noted that if the final value is equal to |α×γ/(α×γ+β)|, any method can be employed to perform the calculation, as long as the detection complex amplitude value is multiplied by the correction complex value.

In the second tracking control device according to the present invention, it is preferable that a numerical value group constituting a single cycle of the first disturbance value group is constituted by N disturbance values that are obtained by substantially equally dividing the time period of the single cycle, that the phase of the correction complex value is substantially 2π/N/2, and that the phase of the predetermined complex amplitude value is substantially 0. This is because the phase difference between the disturbance generating function that corresponds to the first disturbance value group and the first disturbance value group becomes −2π/N/2.

In the second tracking control device according to the present invention, it is preferable that the phase of the correction complex value is substantially 2π/N/2, and that when the frequency of the first disturbance value group is fm and the processing time at the arithmetic means for generating the drive signal from the tracking error signal is Td, the phase of the predetermined complex amplitude value is substantially 2π×fm×Td. A change in the gain of the tracking servo system that is dependent on the processing time at the arithmetic means can be inhibited.

In the first and the second tracking control devices according to the present invention, it is preferable that a numerical value group constituting a single cycle of the first disturbance value group is constituted by N disturbance values that are obtained through a substantially equal division in terms of time, and that the tracking control devices further include a storage portion for storing the N disturbance values. In the disturbance addition portion, because the first disturbance value group has periodicity, values that are identical between cycles can be used as disturbance values. Therefore, if the storage portion is provided and the N disturbance values are stored in that portion, any disturbance value can be extracted from the storage portion. Thus, processing can be performed at a higher speed than in the case where each of the disturbance values is calculated through a calculation. In the present specification, dividing substantially equally means that an unequal division is not intentionally performed, and includes the case where an exactly equal division is not performed due to a calculation error, a production error, or the like.

In the first and the second tracking control devices according to the present invention, it is preferable that the phase of the second disturbance value group is substantially identical to the phase of the first disturbance value group, and that the phase of the third disturbance value group is shifted from the phase of the second disturbance value group substantially by π/2. This is because the detection complex amplitude value can be detected precisely. In the present specification, being shifted substantially by π/2 means that the phase difference is not intentionally set to a value other than π/2, and includes the case where the phase difference is not exactly π/2 due to a calculation error, a production error, or the like.

In the first and the second tracking control devices according to the present invention, it is preferable that the response detection portion detects the detection complex amplitude value based on a plurality of tracking error values that are input during a period of time that is an integral multiple of the cycle of the first disturbance value group. This is because a measurement error of the detection complex amplitude value can be reduced. In particular, when the number of numerical values constituting a single cycle of the first disturbance value group is small (when the division number is small), the effect increases.

In the first and the second tracking control devices according to the present invention, it is preferable that a numerical value group constituting a single cycle of the first disturbance value group is constituted by disturbance values, the number of which is an integral multiple of 4, that are obtained by substantially equally dividing the time period of the single cycle.

Hereinafter, embodiments of the present invention will be described with reference to the drawings.

### EMBODIMENT 1

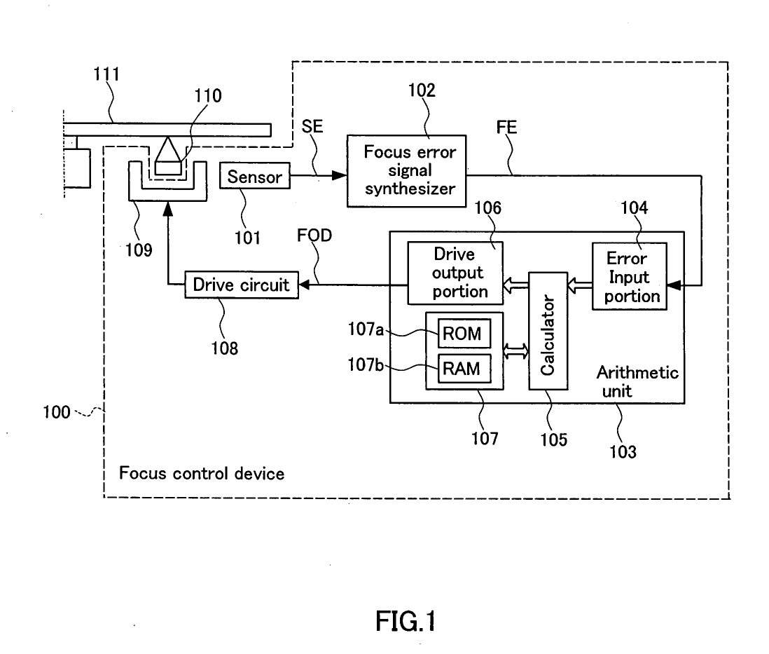

FIG. 1 is a block diagram showing a configuration of a focus control device 100 according to Embodiment 1. The focus control device 100 includes a sensor (sensor means) 101. The sensor 101 receives light reflected from an optical disk 111 and outputs a plurality of sensor signals SE to an error signal synthesizer (error signal synthesizing means) 102. The error signal synthesizer 102 arithmetically synthesizes a plurality of sensor signals SE to obtain a focus error signal FE and supplies it to an arithmetic unit (arithmetic means) 103.

The arithmetic unit 103 has an error input portion 104, a calculator 105, a drive output portion 106, and a memory 107. In the memory 107, a ROM 107a and a RAM 107b are provided.

The error input portion 104 sequentially generates focus error values based on the focus error signal FE synthesized by the error signal synthesizer 102 and supplies them to the calculator 105. A plurality of focus error values that are generated sequentially is a focus error value group.

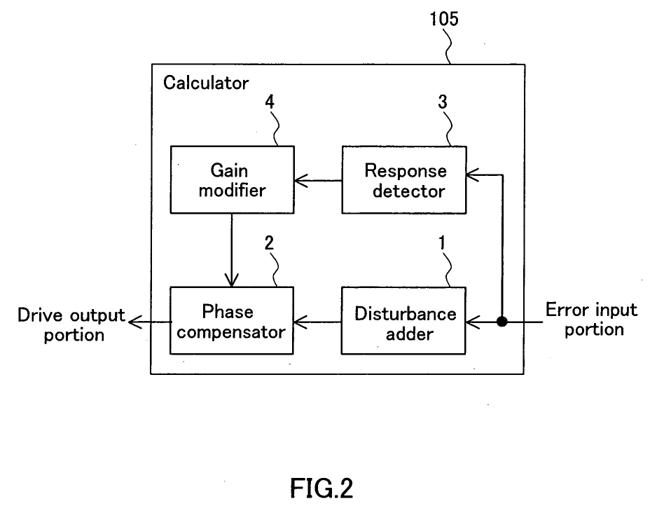

FIG. 2 is a block diagram showing a configuration of the calculator 105. The calculator 105 has a disturbance adder (disturbance addition portion) 1. The disturbance adder 1 adds a disturbance value to the focus error value generated by the error input portion 104 and produces an output. The calculator 105 is provided with a phase compensator (phase compensation portion) 2. The phase compensator 2 performs at least a phase compensation calculation and an amplification calculation on the output value of the disturbance adder 1 and outputs a drive value. The calculator 105 has a response detector (response detection portion) 3. The response detector 3 detects a detection complex amplitude value that responds to the disturbance value based on the focus error value generated by the error input portion 104. The calculator 105 is provided with a gain modifier (gain modification portion) 4. The gain modifier 4 modifies an amplification calculation gain of the phase compensator 2 according to the detection complex amplitude value detected by the response detector 3, a predetermined complex amplitude value, and a correction complex value for correcting the predetermined complex amplitude value.

The drive output portion 106 outputs a drive signal to a drive circuit (driving means) 108 based on the drive value output from the phase compensator 2. The drive circuit 108 outputs a driving current that is approximately proportional to the drive signal to a focus actuator 109. The focus actuator 109 drives an objective lens 110 according to the driving current.

The operation of the focus control device 100 that is configured in this manner will be described.

When the sensor 101 converts light reflected from the optical disk 111 into electric signals and outputs a plurality of sensor signals SE, the error signal synthesizer 102 outputs a focus error signal FE in response to the input of a plurality of sensor signals SE.

In the error signal synthesizer 102, for example, when a plurality of sensor signals SE are referred to respectively as “sensor signal A”, “sensor signal B”, “sensor signal C”, and “sensor signal D”, a signal obtained through the calculation (A+B)−KE×(C+D) using the sensor signals A, B, C, and D is output as the focus error signal FE. Here, KE is a predetermined real number.

The arithmetic unit 103 receives the focus error signal FE from the error signal synthesizer 102 and outputs a drive signal FOD by performing a calculation in accordance with a program described below that is contained in the memory 107. The drive signal FOD that is output from the arithmetic unit 103 is input to the drive circuit 108. Then, the drive circuit (driving means) 108 performs power amplification and supplies electric power to the focus actuator 109 to drive the objective lens 110.

In this manner, the focus control device is constituted by the sensor 101, the error signal synthesizer 102, the arithmetic unit 103, the focus actuator 109, and the drive circuit 108.

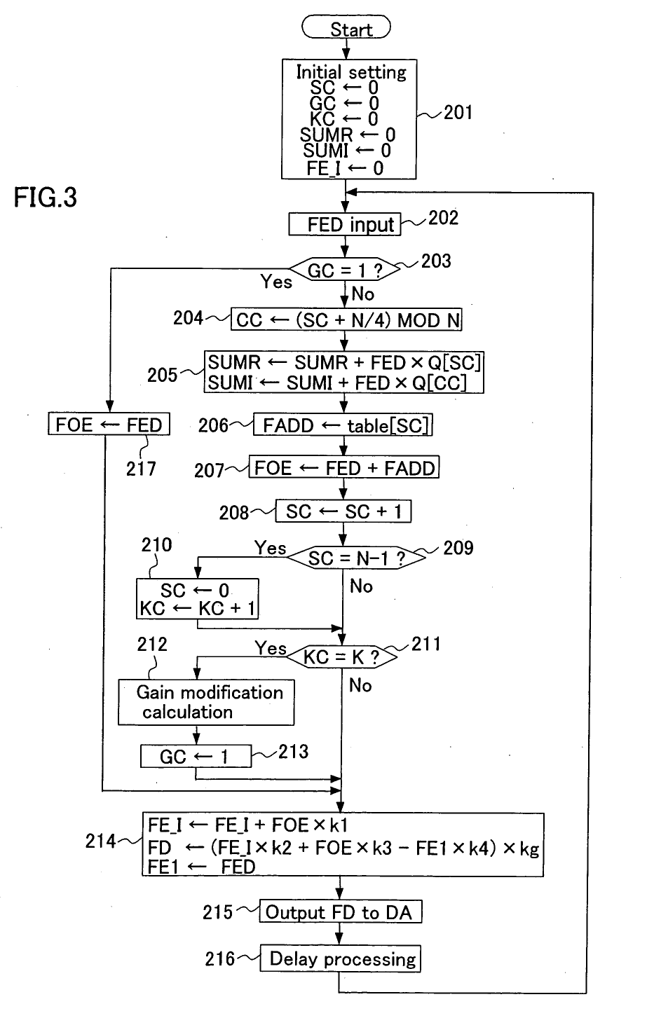

The memory 107 that is provided in the arithmetic unit 103 shown in FIG. 1 is partitioned into a ROM region 107a (ROM: read-only memory) in which a predetermined program and constants are stored and a RAM region 107b (RAM: random-access memory) in which a required variable value is stored whenever necessary. The calculator 105 executes predetermined operations and calculations according to the program in the ROM region 107a. FIG. 3 shows a specific example of the program. Hereinafter, the operation will be described in detail.

First, variable values that are needed for the processes described later are initialized in a process 201. More specifically, the process is started by initializing a reference value table pointer SC(SC←0). Here, the value of the reference value table pointer SC is 0 or a positive integer and takes a value from 0 to N−1. N is the number of disturbance values that are contained in a single cycle of a disturbance value group, that is, the number of divisions of a single cycle of a disturbance value group. In Embodiment 1, the division number N is a positive integer that is a multiple of 4 (in an example, N is 20).

Next, a focus gain adjustment completion flag GC is initialized (GC←0). Here, the focus gain adjustment completion flag GC takes a value that is 0 or 1, and the value 0 means that a focus gain adjustment is not completed, and the value 1 means that the focus gain adjustment is completed. Therefore, by initializing the focus gain adjustment completion flag GC, a setting is made in that the focus gain adjustment is not completed.

Then, a wave number counter KC for counting the number of waves of a sine wave is initialized (KC←0). Here, the value of the wave number counter KC is a positive integer and takes a value from 0 to K. K represents the number of waves that are measured, and is a positive integer of 3 or more (in the example, K is 50). Furthermore, the real part SUMR of a detection complex amplitude value (α) that is detected in a response detection process 205 described later and the imaginary part SUMI of the detection complex amplitude value are initialized (SUMR←0, SUMI←0).

Furthermore, in the process 201, the value of a variable FE_I is initialized to 0 (FE_I←0) as an initial setting for the operation of a phase compensation process 214 described later. Then, the operation of a process 202 is performed.

In the process 202, the input operation of a focus error value FED is performed. That is to say, the focus error signal FE from the error signal synthesizer 102 that was input to the error input portion 104 of the arithmetic unit 103 is subjected to AD conversion and changed into the focus error value FED. Then, the operation of a process 203 is performed.

In the process 203, a process to be performed subsequently is selected in accordance with the value of the focus gain adjustment completion flag GC. More specifically, when the value of the focus gain adjustment completion flag GC is 1, the procedure goes to the operation of a process 217, while when the value of the focus gain adjustment completion flag GC is not 1, the procedure goes to the operation of a process 204. With this process 203, the following configuration is achieved: when the focus gain adjustment is completed, the procedure goes to the operation of the process 217, and only the first cycle of the operation of a gain modification process 212 described later is performed.

In the process 204, the quotient of the division number N divided by 4 is added to the reference value table pointer SC, and the sum modulo the division number N is calculated and taken as the value of a cosine wave table pointer CC. That is to say, the calculation of CC←(SC+N/4) MOD N is performed. Here, A MOD B represents A modulo B. For example, when A=24 and B=20, A MOD B is 4. That is to say, A MOD B represents the remainder of division of the value A by the value B. By performing such a calculation, the value of the cosine wave table pointer CC takes a numerical value in the range from 0 to N−1. Then the operation of a process 205 is performed.

In the process 205, a reference value Q[SC] (a disturbance value constituting a second disturbance value group) is obtained by referencing a reference value table that is stored in the ROM region 107a of the memory 107, based on the reference value table pointer SC. The reference value Q[SC] is multiplied by the focus error value FED, and the sum of the product and the real part SUMR of the detection complex amplitude value is taken as the real part SUMR of a new detection complex amplitude value (SUMR←SUMR+FED×Q[SC]). Here, Q[SC] in the case of the reference value table pointer SC is expressed by Formula 1:

$$Q [ SC ] = P \times sin ( \frac{2 π}{N} \times SC ) \qquad Formula 1$$

In Formula 1, P represents a reference value amplitude, N represents the division number, and π represents the ratio of the circumference of a circle to its diameter. The reference value amplitude P is a positive real number (in the example, P is 100).

Furthermore, in the process 205, a reference value Q[CC] (a disturbance value constituting a third disturbance value group) is obtained by referencing the reference value table that is stored in the ROM region 107a of the memory 107, based on the cosine wave table pointer CC. The reference value Q[CC] is multiplied by the focus error value FED, and the sum of the product and the imaginary part SUMI of the detection complex amplitude value is taken as the imaginary part SUMI of a new detection complex amplitude value (SUMI←SUMI+FED×Q[CC]).

Here, by the operation of the process 204, the difference between the reference value table pointer SC and the cosine wave table pointer CC is set to N/4 (here, N is the division number). Thus, the phase difference between the value of the reference value Q[SC] and the value of the reference value Q[CC] is 2π/4. Therefore, in Embodiment 1, the phase difference between the phase of the second disturbance value group and the phase of the third disturbance value group is precisely set to 2π/4 by setting the division number N to a multiple of 4. Moreover, the number of calculations required to calculate a sin function and a cos function is reduced by using a common reference value table for the reference value Q[SC] and the reference value Q[CC]. After the process 205, the operation of a process 206 is performed. Here, the process 205 corresponds to the response detector 3 shown in FIG. 2.

In the process 206, a disturbance value FADD (a disturbance value constituting a first disturbance value group) is obtained by referencing a sine wave function table that is stored in the ROM region 107a of the memory 107, based on the reference value table pointer SC (FADD←table[SC]). Here, table[SC] is expressed by Formula 2:

$$table [ SC ] = Ad \times sin ( \frac{2 π}{N} \times SC ) \qquad Formula 2$$

In Formula 2, Ad represents a disturbance value amplitude, N represents the division number, and π represents the ratio of the circumference of a circle to its diameter. The disturbance value amplitude Ad is a positive real number (in the example, Ad is 100). In the example, a numerical value table can be used as both the sine wave function table and the reference value table, as shown in Formula 3 below, so that the memory region can be reduced. Therefore, in view of the memory capacity, it is preferable that the value of the disturbance value amplitude Ad and the value of the reference value amplitude P are set to be equal.

$$table [ SC ] = Ad \times sin ( \frac{2 π}{N} \times SC ) = P \times sin ( \frac{2 π}{N} \times SC ) = Q [ SC ] \qquad Formula 3$$

After the operation of the process 206, the operation of a process 207 is performed. In the process 207, the disturbance value FADD is added to the focus error value FED, and the sum is taken as an error signal FOE (FOE←FED+FADD). Then, the operation of a process 208 is performed. Here, the process 207 corresponds to the process that is performed in the disturbance adder (disturbance addition portion) 1 shown in FIG. 2.

In the process 208, 1 is added to the value of the reference value table pointer SC, and the sum is taken as the value of a new reference value table pointer SC (SC←SC+1). By such a process, the reference value table pointer SC takes a value that increases by increments of 1. Then, the operation of a process 209 is performed.

In the process 209, a process to be performed subsequently is selected in accordance with the reference value table pointer SC and the value of the division number N. That is to say, when the value of the reference value table pointer SC is equal to the value of N−1, the procedure goes to the operation of a process 210. When the value of the reference value table pointer SC is not equal to the value of N−1, the procedure goes to the operation of a process 211.

Here, the fact that the reference value table pointer SC that increases by increments of 1 becomes equal to N−1 by the operations of the processes 208 and 209 corresponds to the fact that the entire reference value table (three sets of N disturbance values constituting a single cycle of the first disturbance value group, the second disturbance value group, and the third disturbance value group, respectively) that is used in the processes 205 and 206 is referenced sequentially. This means that a single cycle of the first disturbance value group is obtained in the process 206, and that in the process 207, the N (equivalent to a single cycle) disturbance values FADD that are referenced sequentially are added to N focus error values that are input sequentially.

In the process 210, the value of the reference value table pointer SC is set to 0 (SC←0). That is to say, the reference value table pointer SC is initialized.

Furthermore, in the process 210, a value obtained by adding 1 to the value of the wave number counter KC is taken as the value of a new wave number counter KC (KC←KC+1). By such a process, the wave number counter KC takes a value that increases by increments of 1. Then, the operation of the process 211 is performed. By the operation of the process 210, the wave number counter KC increases by an increment of 1 each time that the N disturbance values FADD are added to the N focus error values.

In the process 211, a process to be performed subsequently is selected in accordance with the value of the wave number counter KC and the value of the number K of waves that are measured. That is to say, when the value of the wave number counter KC is equal to the value of the number K of waves that are measured, the procedure goes to the operation of the process 212. When the value of the wave number counter KC is not equal to the value of the number K of waves that are measured, the procedure goes to the operation of the process 214.

In the process 212, the operation of the gain modifier 4 (gain modification portion) shown in FIG. 2 is performed. That is to say, a focus gain adjustment is made by performing a gain modification calculation. Hereinafter, a specific operation of the gain modifier 4 will be described.

First, a correction complex amplitude value RU that is obtained by correcting the predetermined complex amplitude value (β) with the correction complex value (γ) in the gain modifier 4 is calculated in advance and given by Formula 4 below:

$$\begin{matrix}RU = Re ( RU ) + j \cdot Im ( RU ) = \frac{K \cdot N \cdot P}{2} \cdot Ad \cdot cos ( d 1 ) + \\ j \cdot \{ - \frac{K \cdot N \cdot P}{2} \cdot Ad \cdot sin ( d 1 ) \} \\ = \frac{K \cdot N \cdot P}{2} \cdot Ad \cdot \{ cos ( - d 1 ) + j \cdot sin ( - d 1 ) \}\end{matrix} \qquad Formula 4$$

In Formula 4, Re(RU) represents the real part of the correction complex amplitude value RU, and Im(RU) represents the imaginary part of the correction complex amplitude value RU. K is the number of waves that are measured, N is the number of divisions of a single cycle of a disturbance value group (disturbance values), P is the reference value amplitude, and Ad is the disturbance value amplitude. Moreover, j represents an imaginary number and is defined by Formula 5 below:
j=\sqrt{−1} Formula 5

The phase −d1 of the correction complex amplitude value RU is as set forth in Formula 6 below. Here, K×N×P×Ad/2 (a positive real number having a phase of 0) is the predetermined complex amplitude value, and cos(−d1)+j sin(−d1) is the correction complex value (having a phase of −d1).

In Formula 6, π represents the ratio of the circumference of a circle to its diameter. Since all of the constants are known before the operation of the response detector 3, the correction complex amplitude value RU can be calculated in advance.

$$- d 1 = - \frac{2 π}{2 \cdot N} \qquad Formula 6$$

Next, in the gain modifier 4, the magnitude of the value of an amplification calculation gain kg of the phase compensator 2 that will be described later is corrected using the correction complex amplitude value RU and the detection complex amplitude value (SUMR+j·SUMI) that was detected by the response detector 3. More specifically, a corrected amplification calculation gain kg′ that is obtained by correcting the amplification calculation gain kg using Formula 7 below is taken as the value of a new amplification calculation gain kg.

$$\begin{matrix}{kg}^{′} = \frac{kg}{\vert H \vert} = \frac{kg}{\vert \frac{SUMR + j \cdot SUMI}{( SUMR + j \cdot SUMI ) + \{ Re ( RU ) + j \cdot Im ( RU ) \}} \vert} \\ = \frac{kg}{\vert \frac{SUMR + j \cdot SUMI}{\begin{matrix}( SUMR + j \cdot SUMI ) + \frac{K \cdot N \cdot P}{2} \cdot \\ Ad \cdot \{ cos ( - d 1 ) + j \cdot sin ( - d 1 ) \}\end{matrix}} \vert}\end{matrix} \qquad Formula 7$$

In Formula 7, |H| is a gain of an open-loop transfer function of a focus servo system at a measurement frequency fm and is expressed by Formula 8 below:

$$\vert H \vert = \vert \frac{SUMR + j \cdot SUMI}{( SUMR + j \cdot SUMI ) + \{ Re ( RU ) + j \cdot Im ( RU ) \}} \vert \qquad Formula 8$$

The measurement frequency fm in Formula 8 is expressed by Formula 9 below:
fm=fs/N Formula 9

In Formula 9, fs represents a sampling frequency, and N represents the division number. (In the example, the sampling frequency fs is set to 100 kHz. In this case, since the division number N is 20, the measurement frequency fm is 5 kHz.)

That is to say, the value of the amplification calculation gain kg is corrected (changed to the value of the corrected amplification calculation gain kg′) by determining the gain |H| of the focus servo system at the measurement frequency fm and multiplying the value of the amplification calculation gain kg by the inverse number of that gain. Thus, the gain of the focus servo system can be adjusted precisely to 0 dB (unity) at the measurement frequency fm. That is to say, the focus gain adjustment is performed.

After the operation of the process 212, the operation of a process 213 is performed. In the process 213, the value of the focus gain adjustment completion flag GC is set to 1 (GC←1). Here, setting the value of the focus gain adjustment completion flag GC to 1 means that the operation of the gain modifier 4 is completed, and that the focus gain adjustment is completed. Then, the operation of the process 214 is performed.

In the process 214, a phase compensation calculation and an amplification calculation are performed on the error signal FOE. More specifically, first, a value of k1 (here, k1 is a positive real number) times the error signal FOE is added to the variable FE_I, and the sum is taken as the value of a new variable FE_I (FE_I←FE_I+FOE×k1). Moreover, a value of k2 (here, k2 is a positive real number) times the value of the variable FE_I and a value of k3 (here, k3 is a positive real number) times the value of the error signal FOE are added, and the sum is decreased by a value of k4 (here, k4 is a positive real number less than k3) times the value of a variable FE1 that will be described later. Then, the difference is multiplied by the value of the amplification calculation gain kg, and the product is taken as the value of a variable FD [FD←(FE_I×k2+FOE×k3−FE1×k4)×kg]. Furthermore, the value of the error signal FED is taken as a new value of the variable FE1(FE1←FED). Then, the operation of a process 215 is performed.

By performing this calculation, the error signal FOE is subjected to phase compensation and amplification, and the result is the value of the variable FD. Here, the process 214 corresponds to the process in the phase compensator 2.

In the process 215, the content of the variable FD is output to the drive output portion 106 of the arithmetic unit 103 and converted into a drive signal FOD that is proportional to the value of the Variable FD. Then, the operation of a process 216 is performed.

In the process 216, a delay process is performed for a predetermined period of time. That is to say, the delay operation is performed so that the error input portion 104 and the drive output portion 106 operate at a predetermined sampling frequency fs. Then, the procedure goes back to the operation of the process 202.

In the process 217, the value of the focus error value FED is taken as the error signal FOE (FOE←FED). Then, the operation of the process 214 is performed. That is to say, after the value of the focus gain adjustment completion flag GC is set to 1 in the process 213, the operation of the process 217 is performed each time the error input portion 104 operates because of the operation of the process 203. That is to say, after the sampling timing that comes subsequent to the end of the operation of the gain modifier 4, the operation of the process 217 is performed instead of the operations of the processes 204 to 213.

In the foregoing, the focus control device is constituted by the sensor 101, the error signal synthesizer 102, the arithmetic unit 103, the focus actuator 109, and the drive circuit 108, and the arithmetic unit 103 is constituted by the error input portion 104, the disturbance adder 1, the phase compensator 2, the drive output portion 106, the response detector 3, and the gain modifier 4.

With a focus control device that is configured in this way, the gain of the focus servo system can be adjusted precisely independently of the value of the division number N. More specifically, by the operation of the gain modification process 212, the amplification calculation gain kg is adjusted in the phase compensation process 214 so that the gain of the focus servo system is 0 dB (unity) at the measurement frequency fm. In the following, this will be described in detail.

In Embodiment 1, the gain of the focus servo system is adjusted to a desired value through the gain modification process 212 (operation of the gain modifier 4). Hereinafter, adjustment of the gain of the focus servo system to a desired value will be described, focusing on the gain modification process 212.

In the gain modification process 212, the correction complex amplitude value RU having the phase expressed by Formula 6 and the detection complex amplitude value (SUMR+j·SUMI) are employed to change the amplification calculation gain kg, as described above. Thus, the focus gain adjustment is performed. Here, the focus gain adjustment means that the gain of the focus servo system becomes 0 dB (0 dB means unity) at the measurement frequency fm.

In the gain modification process 212, the amplification calculation gain kg is updated using Formula 7 described above. The following is a detailed description showing that |H| is the gain of the open-loop transfer function of the focus servo system at the measurement frequency fm.

First, when the reference value table pointer SC is SC, the disturbance value FADD that is added in the disturbance addition process 207 is expressed by Formula 2 described above. Moreover, a response Y[SC] of the focus servo system to the disturbance value FADD that is expressed by Formula 2 can be expressed by Formula 10 below, provided that the focus servo system is linear.

$$Y [ SC ] = R \cdot sin ( \frac{2 π}{N} \times SC + θ ) \qquad Formula 10$$

In Formula 10, R represents an amplitude of the response Y[SC] of the focus servo system, and θ represents a phase difference between the response Y of the focus servo system and the first disturbance value group.

Therefore, when the detection complex amplitude value (SUMR+j·SUMI) in the response detection process 206 is calculated using Formulae 1 and 10, the real part SUMR of the detection complex amplitude value is as show by Formula 11 below. Similarly, the imaginary part SUMI of the detection complex amplitude value is as shown by Formula 12 below.

$$\begin{matrix}SUMR = {\sum }_{KC = 0}^{K} {\sum }_{SC = 0}^{N - 1} {Y}_{KC} [ SC ] Q [ SC ] ≅ K {\sum }_{SC = 0}^{N - 1} Y [ SC ] Q [ SC ] \\ = K {\sum }_{SC = 0}^{N - 1} P \cdot R \cdot sin ( \frac{2 π}{N} \times SC + θ ) \cdot sin ( \frac{2 π}{N} \times SC ) \\ = \frac{K \cdot R \cdot P}{2} {\sum }_{SC = 0}^{N - 1} [ cos ( θ ) - cos ( 2 \frac{2 π}{N} \times SC + θ ) ] \\ = \frac{K \cdot N \cdot R \cdot P}{2} cos ( θ ) = \frac{K \cdot N \cdot P}{2} Re ( Y )\end{matrix} \qquad Formula 11$$

$$SUMI = \frac{K \cdot N \cdot P}{2} Im ( Y ) \qquad Formula 12$$

In Formulae 11 and 12, Y is a complex amplitude of the response Y[SC] of the focus servo system, Re(Y) represents the real part of the response Y, and Im(Y) represents the imaginary part of the response Y. It should be noted that Y_{KC}[SC] represents the response of the focus servo system for every value of the wave number counter KC (for every cycle).

In Embodiment 1, when the detection complex amplitude value is calculated in the response detection process 205, integration is performed over an interval corresponding to a time period that is K (K is the number of waves that are measured) multiples of the cycle of the first disturbance value group. Thus, the values of SUMR and SUMI of the detection complex amplitude value correspond respectively to the real part and the imaginary part of the complex amplitude Y more precisely. That is to say, the amplitude and phase of the complex amplitude of the response Y of the focus servo system can be detected precisely.

When Formulae 11, 12, and 4 are substituted into Formula 8, the gain |H| becomes Formula 13 below:

$$\begin{matrix}\vert H \vert = \vert \frac{SUMR + j \cdot SUMI}{\begin{matrix}( SUMR + j \cdot SUMI ) + \\ \{ Re ( RU ) + j \cdot Im ( RU ) \}\end{matrix}} \vert \\ = \vert \frac{\frac{KNP}{2} Y}{\frac{KNP}{2} Y + \frac{KNP}{2} \{ \begin{matrix}cos ( - d 1 ) + \\ j \cdot sin ( - d 1 )\end{matrix} \} \cdot A d } \vert \\ = \vert \frac{Y}{Y + \{ cos ( - d 1 ) + j \cdot sin ( - d 1 ) \} \cdot A d} \vert\end{matrix} \qquad Formula 13$$

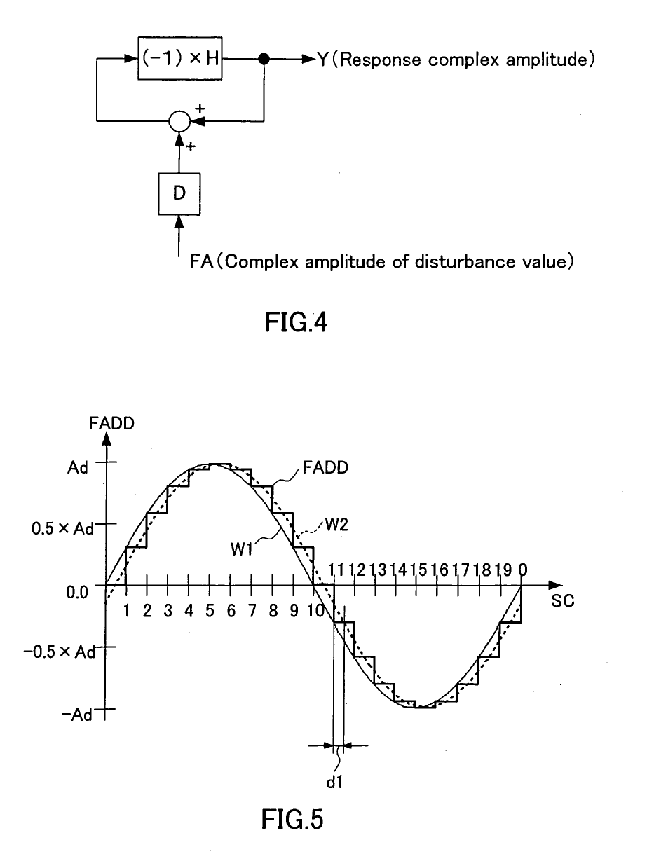

On the other hand, FIG. 4 shows a block diagram of the focus servo system. From FIG. 4, the closed-loop characteristics of the focus servo system, from the disturbance value FADD of the focus servo system to the response Y[SC] of the focus servo system, are expressed by Formula 14 below:

$$\frac{Y}{F A} = D \cdot \frac{- H}{1 + H} \qquad Formula 14$$

In Formula 14, FA represents a disturbance complex amplitude value of the disturbance value FADD when the reference value table pointer SC is SC, Y represents a response complex amplitude value of the response Y[SC] of the focus servo system to the disturbance value FADD, H represents the open-loop transfer function of the focus servo system, and D represents a transfer function of a substantial disturbance addition portion for adding the disturbance value FADD to the focus servo system.

Based on Formula 4 described above, the disturbance complex amplitude value FA is given by Formula 15 below:
FA=Re(FA)+j·Im(FA)=Ad Formula 15

Furthermore, from Formulae 14 and 15, Formula 16 below can be obtained:

$$H = - \frac{Y}{Y + D \cdot A d} \qquad Formula 16$$

When comparing Formula 13 to Formula 16, it is found that |H| is the gain of the open-loop transfer function of the focus servo system at the measurement frequency fm.

Lastly, the transfer function D of the addition portion will be described. FIG. 5 shows the state of output values of the disturbance value FADD. The vertical axis indicates the value of the disturbance value FADD, and the horizontal axis indicates the value of the reference value table pointer SC. As shown in FIG. 5, the output values of the disturbance value FADD have a staircase pattern in which the value of the disturbance value FADD changes at every sampling timing (each time that the value of the reference value table pointer SC changes). In FIG. 5, a waveform FADD is the waveform of the disturbance value FADD that is output sequentially (waveform of the first disturbance value group). That is to say, a sine wave value (in FIG. 5, sine wave values are shown by a waveform W1 (disturbance generating function)) is sampled at every sampling timing and forms a waveform to which zero-order holding is applied. The transfer function of a process in which such sampling and zero-order holding are performed is represented by Formula 17 below:

$$\begin{matrix}\frac{1 - exp ( - j \cdot 2 π \cdot \frac{fm}{fs} )}{j \cdot 2 π \cdot \frac{fm}{fs}} = \frac{1 - exp ( - j \cdot 2 π \cdot \frac{1}{N} )}{j \cdot 2 π \cdot \frac{fm}{fs}} \\ = exp ( - j \frac{ 2 π}{2 N} ) \frac{sin ( \frac{2 π}{2 N} )}{\frac{2 π}{2 N}}\end{matrix} \qquad Formula 17$$

In Formula 17, fm represents the measurement frequency, fs represents the sampling frequency, and N represents the division number.

From the foregoing, the transfer function D of the substantial addition portion for adding the first disturbance value group to the focus servo system can be expressed by Formula 17 described above. That is to say, Formula 18 is obtained:

$$\begin{matrix}D = exp ( - j \frac{2 π}{2 N} ) \frac{sin ( \frac{2 π}{2 N} )}{\frac{2 π}{2 N}} ≅ exp ( - j \frac{2 π}{2 N} ) \\ = cos ( - d 1 ) + j \cdot sin ( - d 1 )\end{matrix} \qquad Formula 18$$

Here, in the example given in Embodiment 1, the division number N of the first disturbance value group is set to 20, so that Formula 19 below holds:

$$\frac{sin ( \frac{2 π}{2 N} )}{\frac{2 π}{2 N}} = 0.996 \qquad Formula 19$$

A waveform W2 shown in FIG. 5 is a waveform having a phase that is delayed from the phase of the waveform W1 by 2π/N/2. Moreover, it is also seen from FIG. 5 that the waveform FADD (the first disturbance value group) has a phase delay of about 2π/N/2.

From the foregoing, it is found that the transfer function of the disturbance addition portion 1 is the transfer function D of the addition portion. Thus, it is found that the gain |H| of the focus servo system at the measurement frequency fm is Formula 8 described above. Furthermore, it is found that the amplification calculation gain kg is corrected to a desired value by Formula 7 and that the gain of the focus servo system can be adjusted precisely to 0 dB (unity) at the measurement frequency fm.

In this manner, the gain of the focus servo system can be adjusted precisely to 0 dB (unity) at the measurement frequency fm because the phase of the correction complex amplitude value RU in the gain modification process 212 is set as given by Formula 6. Moreover, it is also found from the description above that Formula 6 corresponds to the substantial phase of the first disturbance value group that is constituted by the disturbance value FADD for the focus servo system.

Moreover, in Embodiment 1, the phase of the correction complex amplitude value RU in the gain modification process 212 is changed in accordance with the substantial phase of the disturbance value FADD for the focus servo system, and thus, even when the division number N is reduced, the gain of the focus servo system can be precisely adjusted to 0 dB (unity) at the measurement frequency fm with accuracy.

Furthermore, since the measurement frequency fm can be changed by changing the division number N, the gain of the focus servo system can be adjusted to a desired value.

### EMBODIMENT 2

In Embodiment 2, another embodiment of the focus control device of the present invention will be described. In Embodiment 2, the configuration is the same as that of Embodiment 1, except for the operation of the gain modification process (gain modification portion), and thus the description thereof will be omitted.

In the gain modification process according to Embodiment 2, a predetermined complex amplitude value RU2 is given by Formula 20 below:

$$RU 2 = Re ( RU 2 ) + j \cdot Im ( RU 2 ) = \frac{K \cdot N \cdot P}{2} \cdot A d \qquad Formula 20$$

In Formula 20, Re(RU2) represents the real part of the predetermined complex amplitude value RU2, and Im(RU2) represents the imaginary part of the predetermined complex amplitude value RU2. Furthermore, K is the number of waves that are measured, N is the division number, P is the reference value amplitude, and Ad is the amplitude of the first disturbance value group.

Furthermore, a correction complex value CU is expressed by Formula 21 below:
CU=cos(d2)+j sin(d2) Formula 21

Here, the phase of the predetermined complex amplitude value RU2 is 0, and the phase relative to the correction complex value CU is d2. This phase d2 is in antiphase (2π/2/N) with the phase −d1 in Embodiment 1 that is expressed by Formula 6 described above, and is substantially in antiphase with the phase of the first disturbance value group constituted by the disturbance value FADD with respect to the focus servo system.

In the gain modification process, the amplification calculation gain kg is corrected as shown by Formula 22 below:

$$\begin{matrix}{kg}^{′} = \frac{kg}{\vert H \vert} \\ = \frac{kg}{\vert \frac{( SUMR + j \cdot SUMI ) \cdot \{ cos ( d 2 ) + j sin ( d 2 ) \}}{\begin{matrix}( SUMR + j \cdot SUMI ) \cdot \{ cos ( d 2 ) + j sin ( d 2 ) \} + \\ \frac{K \cdot N \cdot P}{2} \cdot A d\end{matrix}} \vert}\end{matrix} \qquad Formula 22$$

That is to say, the amplification calculation gain kg is corrected (changed to the value of the corrected amplification calculation gain kg′) by determining the gain |H| of the focus servo system at the measurement frequency fm and multiplying the amplification calculation gain kg by the inverse number of that gain. Thus, the gain of the focus servo system can be adjusted precisely to 0 dB (unity) at the measurement frequency fm.

When the gain |H| of the focus servo system is extracted from Formula 22, Formula 23 below is obtained:

$$\vert H \vert = \vert \frac{( SUMR + j \cdot SUMI ) \cdot \{ cos ( d 2 ) + j sin ( d 2 ) \}}{\begin{matrix}( SUMR + j \cdot SUMI ) \cdot \{ cos ( d 2 ) + j sin ( d 2 ) \} + \\ \frac{K \cdot N \cdot P}{2} \cdot A d\end{matrix}} \vert \qquad Formula 23$$

From the foregoing, it is found that Formula 23 is equivalent to Formula 8 described above.

Therefore, in Embodiment 2, by correcting the detection complex amplitude value with the correction complex value CU, the gain of the focus servo system can be adjusted precisely to 0 dB (unity) at the measurement frequency fm with accuracy even when the division number N is reduced.

Furthermore, in addition to the effects of Embodiment 1, Embodiment 2 is configured such that the predetermined complex amplitude value that is used in the gain modification process (operation of the gain modifier) is set to a real value (the phase is 0). Thus, the volume of information to be stored in advance is reduced.

### EMBODIMENT 3

In Embodiment 3, still another embodiment of the focus control device according to the present invention will be described.

In Embodiment 3, the configuration is the same as that of Embodiment 1, except for the gain modification process (operation of the gain modifier), and thus the description thereof will be omitted. Hereinafter, the gain modification process (operation of the gain modifier) in Embodiment 3 is referred to as a gain modification process 412.

In Embodiments 1 and 2, no consideration is given to the phase shift that is dependent on the calculation time in the arithmetic unit 103 (see FIG. 1), but in Embodiment 3, the gain of the focus servo system is adjusted even more accurately by giving consideration to the phase shift that is dependent on the calculation time. That is to say, the phase d2 in Formula 23 described above is replaced by a phase d3 that is expressed by Formula 24 below. The configuration and the operation of the gain modification process, other than this replacement, are the same as those of the gain modification process in Embodiments 1 and 2, and the description thereof will be omitted.

$$d 3 = \frac{2 π}{2 \cdot N} + 2 π \cdot fm \cdot Td \qquad Formula 24$$

In Formula 24, fm represents the measurement frequency, Td represents a calculation time (calculation time of the arithmetic means) Td from the input operation of the error input portion 104 to the output operation of the drive output portion 106. That is to say, the phase d3 of Formula 24 is the sum of 2π/N/2 and 2π×fm×Td. The calculation time Td indicates the length of time by which the execution of the output operation of the drive output portion 106 is delayed from the input operation of the error input portion 104. It should be noted that the present case corresponds to the case where the predetermined complex amplitude value (β) is K·N·P·Ad/2·{cos(−2π×fm×Td)+j sin(−2π×fm×Td)} and the correction complex value (γ) is {cos(2π/N/2)+j sin(2π/N/2)}.

By configuring in this manner, the gain of the focus servo system can be adjusted to 0 dB (unity) more precisely at the measurement frequency fm even when the phase shift (−2π×fm×Td) due to the calculation time Td increases significantly when compared to the phase d1 of Formula 6 described above. Hereinafter, this will be described in detail.

First, when the phase shift due to the calculation time Td is small enough that it is negligible when compared to the phase that is expressed by Formula 6 described above, the value of Formula 6, which is the phase of the first disturbance value group that is used in Embodiments 1 and 2, is approximately equal to the value of Formula 24, and thus, it is found that the gain of the focus servo system can be adjusted to 0 dB (unity) at the measurement frequency fm.

Next, the case where the calculation time Td is significant when compared to the phase value that is expressed by Formula 6 described above will be described.

In this case, the phase shift that is dependent on the calculation time Td is added to the phase that is expressed by Formula 6 described above. The phase shift Tp due to the calculation time Td with respect to the measurement frequency fm of the gain of the focus servo system is Formula 25 below:
TP=2π·fm·Td Formula 25

From the foregoing, Formula 24 can be obtained by adding Formula 25 and Formula 6.

In Embodiment 3, by the operation of the gain modification process, even when the calculation time Td is too long to ignore when compared to the phase value that is expressed by Formula 6, consideration is given to its effect as shown in Formula 24 to calculate the amplification calculation gain kg, and thus the gain of the focus servo system can be adjusted to 0 dB (unity) more precisely at the measurement frequency fm.

In Embodiment 3, a value that is obtained by calculating in advance the phase part of the predetermined complex amplitude value (β) and the correction complex value (a value that is obtained by multiplying the denominator and the numerator of the complex gain H by a complex value that is conjugate with the predetermined complex amplitude value) is used to calculate the gain |H| of the focus servo system. However, the gain can be calculated by other calculation methods, and the present invention is not limited to the calculation method in Embodiment 3.

Moreover, the process 214 in the phase compensator 2 shown in FIG. 2 is not a limitation, and it is sufficient that an operation for compensating the phase of the focus servo system is performed. The present invention includes the case where a phase compensator having a configuration that is different from the configuration of the phase compensator 2 shown in FIG. 2 is provided.

Moreover, in Embodiments 1 to 3, the disturbance value is output for every single sample. However, it is also possible to configure such that the disturbance value is output for every set of multiple samples, and such a modification is of course included in the present invention.

Furthermore, various modifications are possible such as configuring the part that is configured as a digital circuit in Embodiments 1 to 3 as an analog circuit or configuring the part that is configured as an analog circuit as a digital circuit. Of course, the present invention includes such modifications.

As described above, according to Embodiments 1 to 3, the loop gain characteristics of the focus control device can be adjusted accurately by the operation of the gain modifier 4. In particular, even when the division number N is small, the loop gain characteristics of the focus control device can be adjusted accurately. That is to say, in the gain modification process, the loop gain characteristics are adjusted accurately by setting the phase of the correction complex value of the gain modification process to a value according to the phase of the first disturbance value of the disturbance value addition portion, and correcting the detection complex amplitude value or the predetermined complex amplitude value with the correction complex value.

In particular, there is a tendency for the division number N to be reduced progressively because the operating clock is reduced in order to increase the band of the focus servo system and save electric power required for the arithmetic unit. Even in such a case, it is possible to adjust the loop gain characteristics accurately by using the focus control device according to the present embodiment.

### EMBODIMENT 4

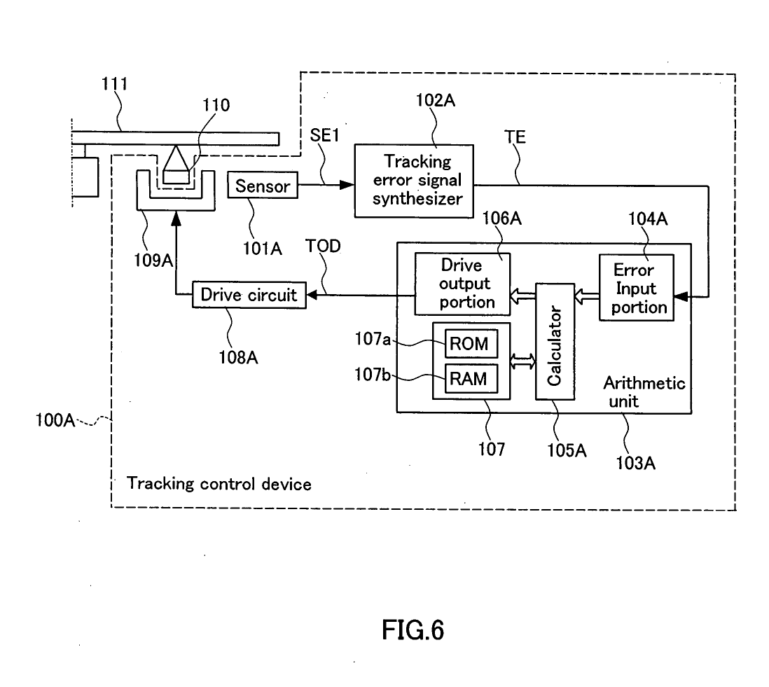

FIG. 6 is a block diagram showing a configuration of a tracking control device 100A according to Embodiment 4. The tracking control device 100A includes a sensor (sensor means) 101A. The sensor 101A receives light reflected from the optical disk 111 and outputs a plurality of sensor signals SE1 to an error signal synthesizer (error signal synthesizing means) 102A. The error signal synthesizer 102A arithmetically synthesizes a plurality of sensor signals SE1 to obtain a tracking error signal TE and supplies it to an arithmetic unit (arithmetic means) 103A.

The arithmetic unit 103A has an error input portion 104A, a calculator 106A, a drive output portion 106A, and a memory 107. In the memory 107, a ROM 107a and a RAM 107b are provided.

The error input portion 104A sequentially generates tracking error values based on the tracking error signal TE synthesized by the error signal synthesizer 102A and supplies them to the calculator 105A. A plurality of tracking error values that are generated sequentially is a tracking error value group.

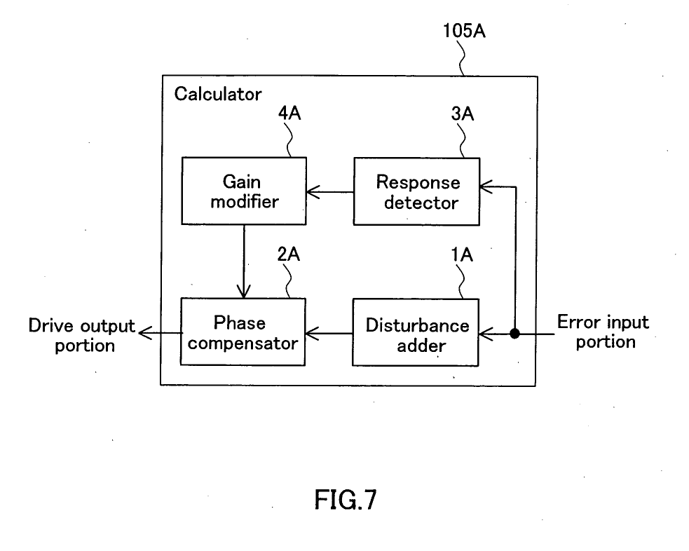

FIG. 7 is a block diagram showing a configuration of the calculator 105A. The calculator 105A has a disturbance adder (disturbance addition portion) 1A. The disturbance adder 1A adds a disturbance value to the tracking error value generated by the error input portion 104A and produces an output. The calculator 105A is provided with a phase compensator (phase compensation portion) 2A. The phase compensator 2A performs at least a phase compensation calculation and an amplification calculation on the output value of the disturbance adder 1A and outputs a drive value. The calculator 105A has a response detector (response detection portion) 3A. The response detector 3A detects a detection complex amplitude value that responds to the disturbance value based on the tracking error value generated by the error input portion 104A. The calculator 105A is provided with a gain modifier (gain modification portion) 4A. The gain modifier 4A modifies an amplification calculation gain of the phase compensator 2A according to the detection complex amplitude value detected by the response detector 3A, a predetermined complex amplitude value, and a correction complex value for correcting the predetermined complex amplitude value.

The drive output portion 106A outputs a drive signal to a drive circuit (driving means) 108A based on the drive value output from the phase compensator 2A. The drive circuit 108A outputs a driving current that is approximately proportional to the drive signal to a tracking actuator 109A. The tracking actuator 109A drives the objective lens 110 according to the driving current.

The operation of the tracking control device 100A that is configured in this manner will be described.

When the sensor 101A converts light reflected from the optical disk 111 into electric signals and outputs a plurality of sensor signals SE1, the error signal synthesizer 102A outputs a tracking error signal TE in response to the input of a plurality of sensor signals SE1.

In the error signal synthesizer 102A, for example, when a plurality of sensor signals SE1 are referred to respectively as “sensor signal A1”, “sensor signal B1”, “sensor signal C1”, and “sensor signal D1”, a signal obtained through the calculation of (A1+B1)−KE1×(C1+D1) using the sensor signals A1, B1, C1, and D1 is output as the tracking error signal TE. Here, KE1 is a predetermined real number.

The arithmetic unit 103A receives the tracking error signal TE from the error signal synthesizer 102A, and outputs a drive signal TOD by performing a calculation in accordance with a program described below that is contained in the memory 107a. The drive signal TOD that is output from the arithmetic unit 103A is input to the drive circuit 108A. Then, the drive circuit (driving means) 108A performs power amplification and supplies electric power to the tracking actuator 109A to drive the objective lens 110.

In this manner, the tracking control device is constituted by the sensor 101A, the error signal synthesizer 102A, the arithmetic unit 103A, the tracking actuator 109A, and the drive circuit 108A.

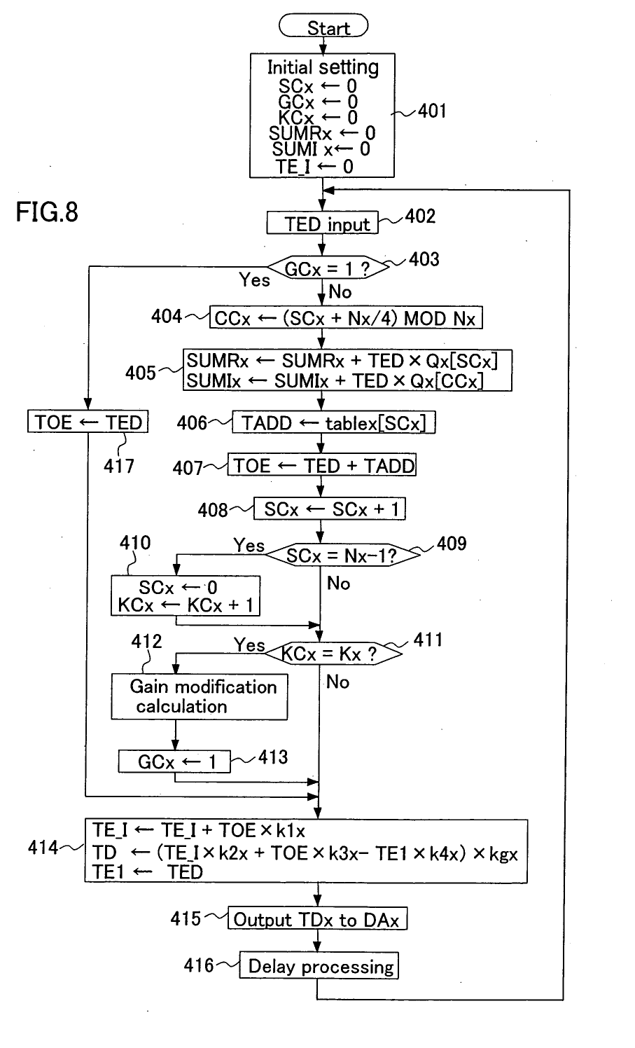

The memory 107 that is provided in the arithmetic unit 103A shown in FIG. 6 is partitioned into a ROM region 107a (ROM: read-only memory) in which a predetermined program and constants are stored and a RAM region 107b (RAM: random-access memory) in which a required variable value is stored whenever necessary. The calculator 105A executes predetermined operations and calculations according to the program in the ROM region 107a. FIG. 8 shows a specific example of the program. Hereinafter, the operation will be described in detail.

First, variable values that are needed for the processes described later are initialized in a process 401. More specifically, the process is started by initializing a reference value table pointer SCx (SCx←0). Here, the value of the reference value table pointer SCx is a positive integer and takes a value from 0 to Nx−1. Nx is the number of disturbance values that are contained in a single cycle of a disturbance value group, that is, the number of divisions of a single cycle of a disturbance value group. In Embodiment 4, the division number Nx is a positive integer that is a multiple of 4 (in an example, Nx is 20).

Next, a tracking gain adjustment completion flag GCx is initialized (GCx←0). Here, the tracking gain adjustment completion flag GCx takes a value that is 0 or 1, and the value 0 means that a tracking gain adjustment is not completed, and the value 1 means that the tracking gain adjustment is completed. Therefore, by initializing the tracking gain adjustment completion flag GCx, a setting is made in that the tracking gain adjustment is not completed.

Then, a wave number counter KCx for counting the number of waves of a sine wave is initialized (KCx←0). Here, the value of the wave number counter KCx is a positive integer and takes a value from 0 to Kx. Kx represents the number of waves that are measured, and is a positive integer of 3 or more (in the example, Kx is 50). Furthermore, the real part SUMRx of a detection complex amplitude value (α) that is detected in a response detection process 405 described later and the imaginary part SUMIx of the detection complex amplitude value are initialized (SUMRx←0, SUMIx←0).

Furthermore, in the process 401, the value of a variable TE_I is initialized to 0 (TE_I←0) as an initial setting for the operation of a phase compensation process 414 described later. Then, the operation of a process 402 is performed.

In the process 402, the input operation of a tracking error value TED is performed. That is to say, the tracking error signal TE from the error signal synthesizer 102A that was input to the error input portion 104A of the arithmetic unit 103A is subjected to AD conversion and changed into the tracking error value TED. Then, the operation of a process 403 is performed.

In the process 403, a process to be performed subsequently is selected in accordance with the value of the tracking gain adjustment completion flag GCx. More specifically, when the value of the tracking gain adjustment completion flag GCx is 1, the procedure goes to the operation of a process 417, while when the value of the tracking gain adjustment completion flag GCx is not 1, the procedure goes to the operation of a process 404. With this process 403, the following configuration is achieved: when the tracking gain adjustment is completed, the procedure goes to the operation of the process 417, and only the first cycle of the operation of a gain modification process 412 described later is performed

In the process 404, the quotient of the division number Nx divided by 4 is added to the reference value table pointer SCx, and the sum modulo the division number Nx is calculated and taken as the value of a cosine wave table pointer CCx. That is to say, the calculation of CCx←(SCx+Nx/4) MOD Nx is performed. Here, A MOD B represents A modulo B. For example, when A=24 and B=20, A MOD B is 4. That is to say, A MOD B represents the remainder of division of the value A by the value B. By performing such a calculation, the value of the cosine wave table pointer CCx takes a numerical value in the range from 0 to Nx−1. Then the operation of the process 405 is performed.

In the process 405, a reference value Qx[SCx] (a disturbance value constituting a second disturbance value group) is obtained by referencing a reference value table that is stored in the ROM region 107a of the memory 107 based on the reference value table pointer SCx. The reference value Qx[SCx] is multiplied by the tracking error value TED, and the sum of the product and the real part SUMRx of the detection complex amplitude value is taken as the real part SUMRx of a new detection complex amplitude value (SUMRx←SUMRx+TED×Qx[SCx]). Here, Qx[SCx] in the case of the reference value table pointer SCx is expressed by Formula 26:

$$Qx [ SCx ] = Px \times sin ( \frac{2 π}{Nx} \times SCx ) \qquad Formula 26$$

In Formula 26, Px represents a reference value amplitude, Nx represents the division number, and π represents the ratio of the circumference of a circle to its diameter. The reference value amplitude Px is a positive real number (in the example, Px is 100).

Furthermore, in the process 405, a reference value Qx[CCx] (a disturbance value constituting a third disturbance value group) is obtained by referencing the reference value table that is stored in the ROM region 107a of the memory 107 based on the cosine wave table pointer CCx. The reference value Qx[CCx] is multiplied by the tracking error value TED, and the sum of the product and the imaginary part SUMIx of the detection complex amplitude value is taken as the imaginary part SUMIx of a new detection complex amplitude value (SUMIx←SUMIx+TED×Qx[CCx]).

Here, by the operation of the process 404, the difference between the reference value table pointer SCx and the cosine wave table pointer CCx is set to Nx/4 (here, Nx is the division number). Thus, the phase difference between the value of the reference value Qx[SCx] and the value of the reference value Qx[CCx] is 2π/4. Therefore, in Embodiment 4, the phase difference between the phase of the second disturbance value group and the phase of the third disturbance value group is precisely set to 2π/4 by setting the division number Nx to a multiple of 4. Moreover, the number of calculations required to calculate a sin function and a cos function is reduced by using a common reference value table for the reference value Qx[SCx] and the reference value Qx[CCx]. After the process 405, the operation of a process 406 is performed. Here, the process 405 corresponds to the response detector 3A shown in FIG. 7.

In the process 406, a disturbance value TADD (a disturbance value constituting a first disturbance value group) is obtained by referencing a sine wave function table that is stored in the ROM region 107a of the memory 107 based on the reference value table pointer SCx (TADD←tablex[SCx]). Here, tablex[SCx] is given by Formula 27:

$$tablex [ SCx ] = Adx \times sin ( \frac{2 π}{Nx} \times SCx ) \qquad Formula 27$$

In Formula 27, Adx represents a disturbance value amplitude, Nx represents the division number, and π represents the ratio of the circumference of a circle to its diameter. The disturbance value amplitude Adx is a positive real number (in the example, Adx is 100). In the example, a numerical value table can be used as both the sine wave function table and the reference value table, as shown in Formula 28 below, so that the memory region can be reduced. Therefore, in view of the memory capacity, it is preferable that the value of the disturbance value amplitude Adx and the value of the reference value amplitude Px are set to be equal.

$$\begin{matrix}tablex [ SCx ] = Adx \times sin ( \frac{2 π}{Nx} \times SCx ) \\ = Px \times sin ( \frac{2 π}{Nx} \times SCx ) \\ = Qx [ SC x ]\end{matrix} \qquad Formula 28$$

After the operation of the process 406, the operation of a process 407 is performed. In the process 407, the disturbance value TADD is added to the tracking error value TED, and the sum is taken as an error signal TOE (TOE←TED+TADD). Then, the operation of a process 408 is performed. Here, the process 407 corresponds to the process that is performed in the disturbance adder (disturbance addition portion) 1A shown in FIG. 7.

In the process 408, 1 is added to the value of the reference value table pointer SCx, and the sum is taken as the value of a new reference value table pointer SCx (SCx←SCx+1). By such a process, the reference value table pointer SCx takes a value that increases by increments of 1. Then, the operation of a process 409 is performed.

In the process 409, a process to be performed subsequently is selected in accordance with the reference value table pointer SCx and the value of the division number Nx. That is to say, when the value of the reference value table pointer SCx is equal to the value of Nx−1, the procedure goes to the operation of a process 410. When the value of the reference value table pointer SCx is not equal to the value of Nx−1, the procedure goes to the operation of a process 411.

Here, the fact that the reference value table pointer SCx that increases by increments of 1 becomes equal to Nx−1 by the operations of the processes 408 and 409 corresponds to the fact that the entire reference value table (three sets of Nx disturbance values constituting a single cycle of the first disturbance value group, the second disturbance value group, and the third disturbance value group, respectively) that is used in the processes 405 and 406 is referenced sequentially. This means that a single cycle of the first disturbance value group is obtained in the process 406, and that in the process 407, the Nx (equivalent to a single cycle) disturbance values TADD that are referenced sequentially are added to Nx tracking error values that are input sequentially.

In the process 410, the value of the reference value table pointer SCx is set to 0 (SCx←0). That is to say, the reference value table pointer SCx is initialized.

Furthermore, in the process 410, a value obtained by adding 1 to the value of the wave number counter KCx is taken as the value of a new wave number counter KCx (KCx←KCx+1). By such a process, the wave number counter KCx takes a value that increases by increments of 1. Then, the operation of the process 411 is performed. By the operation of the process 410, the wave number counter KCx increases by an increment of 1 each time that the Nx disturbance values TADD are added to the Nx tracking error values.

In the process 411, a process to be performed subsequently is selected in accordance with the value of the wave number counter KCx and the value of the number Kx of waves that are measured. That is to say, when the value of the wave number counter KCx is equal to the value of the number Kx of waves that are measured, the procedure goes to the operation of the process 412. When the value of the wave number counter KCx is not equal to the value of the number Kx of waves that are measured, the procedure goes to the operation of the process 414.

In the process 412, the operation of the gain modifier (gain modification portion) 4A shown in FIG. 7 is performed. That is to say, a tracking gain adjustment is made by performing a gain modification calculation. Hereinafter, a specific operation of the gain modifier 4A will be described.

First, a correction complex amplitude value RUx that is obtained by correcting the predetermined complex amplitude value (β) with the correction complex value (γ) in the gain modifier 4A is calculated in advance and given by Formula 29 below:

$$\begin{matrix}RUx = Re ( RUx ) + j \cdot Im ( RUx ) \\ = \frac{Kx \cdot Nx \cdot Px}{2} \cdot Adx \cdot cos ( d 1 x ) + j \cdot \{ \begin{matrix}- \frac{Kx \cdot Nx \cdot Px}{2} \cdot \\ Adx \cdot sin ( d 1 x )\end{matrix} \} \\ = \frac{Kx \cdot Nx \cdot Px}{2} \cdot Adx \cdot \{ cos ( - d 1 x ) + j \cdot sin ( - d 1 x ) \}\end{matrix} \qquad Formula 29$$

In Formula 29, Re(RUx) represents the real part of the correction complex amplitude value RUx, and Im(RUx) represents the imaginary part of the correction complex amplitude value RUx. Kx is the number of waves that are measured, Nx is the number of divisions of a single cycle of a disturbance value group, Px is the reference value amplitude, and Adx is the disturbance value amplitude. Moreover, j represents an imaginary number and is defined by Formula 30 below:
j=\sqrt{−1} Formula 30

The phase −d1x of the correction complex amplitude value RUx is as set forth in Formula 31 below. Here, Kx×Nx×Px×Adx/2 (a positive real number having a phase of 0) is the predetermined complex amplitude value, and cos(−d1x)+j sin(−d1x) is the correction complex value (having a phase of −d1x).

$$- d 1 x = - \frac{2 π}{2 \cdot Nx} \qquad Formula 31$$

In Formula 31, π represents the ratio of the circumference of a circle to its diameter. Since all of the constants are known before the operation of the response detector 3A, the correction complex amplitude value RUx can be calculated in advance.

Next, in the gain modifier 4A, the magnitude of the value of an amplification calculation gain kgx of the phase compensator 2A that will be described later is corrected using the correction complex amplitude value RUx and the detection complex amplitude value (SUMRx+j·SUMIx) that was detected by the response detector 3A. More specifically, a corrected amplification calculation gain kgx′ that is obtained by correcting the amplification calculation gain kgx using Formula 32 below is taken as the value of a new amplification calculation gain kgx.

$$\begin{matrix}{kgx}^{′} = \frac{kgx}{\vert Hx \vert} \\ = \frac{kgx}{\vert \frac{SUMRx + j \cdot SUMIx}{( SUMRx + j \cdot SUMIx ) + \{ Re ( RUx ) + j \cdot Im ( RUx ) \}} \vert} \\ = \frac{kgx}{\vert \frac{SUMRx + j \cdot SUMIx}{( SUMRx + j \cdot SUMIx ) + \frac{Kx \cdot Nx \cdot Px}{2} \cdot \\ Adx \cdot \{ cos ( - d 1 x ) + j \cdot sin ( - d 1 x ) \}} \vert}\end{matrix} \qquad Formula 32$$

In Formula 32, |Hx| is a gain of an open-loop transfer function of a tracking servo system at a measurement frequency fmx and is expressed by Formula 33 below:

$$\vert Hx \vert = \vert \frac{SUMRx + j \cdot SUMIx}{( SUMRx + j \cdot SUMIx ) + \{ Re ( RUx ) + j \cdot Im ( RUx ) \}} \vert \qquad Formula 33$$

The measurement frequency fmx in Formula 33 is expressed by Formula 34 below:
fmx=fsx/Nx Formula 34

In Formula 34, fsx represents a sampling frequency, and Nx represents the division number. (In the example, the sampling frequency fsx is set to 100 kHz. In this case, since the division number Nx is 20, the measurement frequency fmx is 5 kHz.)

That is to say, the value of the amplification calculation gain kgx is corrected (changed to the value of the corrected amplification calculation gain kgx′) by determining the gain |Hx| of the tracking servo system at the measurement frequency fmx and multiplying the value of the amplification calculation gain kgx by the inverse number of that gain. Thus, the gain of the tracking servo system can be adjusted precisely to 0 dB (unity) at the measurement frequency fmx. That is to say, the tracking gain adjustment is performed.

After the operation of the process 412, the operation of a process 413 is performed. In the process 413, the value of the tracking gain adjustment completion flag GCx is set to 1 (GCx←1). Here, setting the value of the tracking gain adjustment completion flag GCx to 1 means that the operation of the gain modifier 4A is completed, and that the tracking gain adjustment is completed. Then, the operation of the process 414 is performed.

In the process 414, a phase compensation calculation and an amplification calculation are performed on the error signal TOE. More specifically, first, a value of k1x (here, k1x is a positive real number) times the error signal TOE is added to the variable TE_I, and the sum is taken as the value of a new variable TE_I (TE_I←TE_I+TOE×k1x). Moreover, a value of k2x (here, k2x is a positive real number) times the value of the variable TE_I and a value of k3x (here, k3x is a positive real number) times the value of the error signal TOE are added, and the sum is decreased by a value of k4x (here, k4x is a positive real number less than k3x) times the value of a variable TE1 that will be described later. Then, the difference is multiplied by the value of the amplification calculation gain kgx, and the product is taken as the value of a variable TD [TD←(TE_I×k2x+TOE×k3x−TE1×k4x)×kgx]. Furthermore, the value of the error signal TED is taken as a new value of the variable TE1(TE1←TED). Then, the operation of a process 415 is performed.

By performing this calculation, the error signal TOE is subjected to phase compensation and amplification, and the result is the value of the variable TD. Here, the process 414 corresponds to the process in the phase compensator 2A.

In the process 415, the content of the variable TD is output to the drive output portion 106A of the arithmetic unit 103A and converted into the drive signal TOD that is proportional to the value of the variable TD. Then, the operation of a process 416 is performed.

In the process 416, a delay process is performed for a predetermined period of time. That is to say, the delay operation is performed so that the error input portion 104A and the drive output portion 106A operate at a predetermined sampling frequency fsx. Then, the procedure goes back to the operation of the process 402.

In the process 417, the value of the tracking error value TED is taken as the error signal TOE (TOE←TED). Then, the operation of the process 414 is performed. That is to say, after the value of the tracking gain adjustment completion flag GCx is set to 1 in the process 413, the operation of the process 417 is performed each time that the error input portion 104A operates because of the operation of the process 403. That is to say, after the sampling timing that comes subsequent to the end of the operation of the gain modifier 4A, the operation of the process 417 is performed instead of the operations of the processes 404 to 413.

In the foregoing, the tracking control device is constituted by the sensor 101A, the error signal synthesizer 102A, the arithmetic unit 103A, the tracking actuator 109A, and the drive circuit 108A, and the arithmetic unit 103A is constituted by the error input portion 104A, the disturbance adder 1A, the phase compensator 2A, the drive output portion 106A, the response detector 3A, and the gain modifier 4A.

With a tracking control device that is configured in this way, the gain of the tracking servo system can be adjusted precisely independently of the value of the division number Nx. More specifically, by the operation of the gain modification process 412, the amplification calculation gain kgx is adjusted in the phase compensation process 414 so that the gain of the tracking servo system is 0 dB (unity) at the measurement frequency fmx. In the following, this will be described in detail.

In Embodiment 4, the gain of the tracking servo system is adjusted to a desired value through the gain modification process 412 (operation of the gain modifier 4A). Hereinafter, adjustment of the gain of the tracking servo system to a desired value will be described, focusing on the gain modification process 412.

In the gain modification process 412, the correction complex amplitude value RUx having the phase expressed by Formula 31 and the detection complex amplitude value (SUMRx+j·SUMIx) are employed to change the amplification calculation gain kgx, as described above. Thus, the tracking gain adjustment is performed. Here, the tracking gain adjustment means that the gain of the tracking servo system becomes 0 dB (0 dB means unity) at the measurement frequency fmx.

In the gain modification process 412, the amplification calculation gain kgx is updated using Formula 32 described above. The following is a detailed description showing that |Hx| is the gain of the open-loop transfer function of the tracking servo system at the measurement frequency fmx.

First, when the reference value table pointer SCx is SCx, the disturbance value TADD that is added in the disturbance addition process 407 is expressed by Formula 27 described above. Moreover, a response Yx[SCx] of the tracking servo system to the disturbance value TADD that is expressed by Formula 27 can be expressed by Formula 35 below, provided that the tracking servo system is linear:

$$Yx [ SCx ] = Rx \cdot sin ( \frac{2 π}{Nx} \times SCx + θ x ) \qquad Formula 35$$

In Formula 35, Rx represents an amplitude of the response Yx[SCx] of the tracking servo system, and θx represents the phase difference between the response Yx of the tracking servo system and the first disturbance value group.

Therefore, when the detection complex amplitude value (SUMRx+j·SUMIx) in the response detection process 406 is calculated using Formulae 26 and 35, the real part SUMRx of the detection complex amplitude value is as shown by Formula 36 below. Similarly, the imaginary part SUMIx of the detection complex amplitude value is as shown by Formula 37 below.

$$\begin{matrix}SUMRx = {\sum }_{KCx}^{Kx} {\sum }_{SCx = 0}^{N - 1} {Yx}_{KCx} [ SCx ] Qx [ SCx ] \\ ≅ {\sum }_{KCx}^{Kx} {\sum }_{SCx = 0}^{N - 1} {Yx}_{KCx} [ SCx ] Qx [ SCx ] \\ = K {\sum }_{SCx = 0}^{N - 1} Px \cdot Rx \cdot sin ( \frac{2 π}{Nx} \times SCx + θ x ) \cdot sin ( \frac{2 π}{Nx} \times SCx ) \\ = \frac{Kx \cdot Rx \cdot Px}{2} {\sum }_{SCx = 0}^{N - 1} [ cos ( θ x ) - cos ( 2 \frac{2 π}{Nx} \times SCx + θ x ) ] \\ = \frac{Kx \cdot Nx \cdot Rx \cdot Px}{2} cos ( θ x ) \\ = \frac{Kx \cdot Nx \cdot Px}{2} Re ( Yx )\end{matrix} \qquad Formula 36$$

$$SUMIx = \frac{Kx \cdot Nx \cdot Px}{2} Im ( Yx ) \qquad Formula 37$$

In Formulae 36 and 37, Yx is a complex amplitude of the response Yx[SCx] of the tracking servo system, Re(Yx) represents the real part of the response Yx, and Im(Yx) represents the imaginary part of the response Yx. It should be noted that Yx_{KC}[SCx] represents the response of the tracking servo system for every value of the wave number counter KCx (for every cycle).

In Embodiment 4, when the detection complex amplitude value is calculated in the response detection process 405, integration is performed over an interval corresponding to a time period that is Kx (Kx is the number of waves that are measured) multiples of the cycle of the first disturbance value group. Thus, the values of SUMRx and SUMIx of the detection complex amplitude value respectively correspond to the real part and the imaginary part of the complex amplitude Yx more precisely. That is to say, the amplitude and phase of the complex amplitude of the response Yx of the tracking servo system can be detected precisely.

When Formulae 36, 37, and 29 are substituted into Formula 33, the gain |Hx| becomes Formula 38 below:

$$\begin{matrix}\vert Hx \vert = \vert \frac{SUMRx + j \cdot SUMIx}{( SUMRX + j \cdot SUMIx ) + \{ Re ( RUx ) + j \cdot Im ( rUx )} \vert \\ = \vert \frac{\frac{KxNxPx}{2} Yx}{\frac{KxNxPx}{2} Yx + \frac{KxNxPx}{2} \{ \begin{matrix}cos ( - d 1 x ) + j \cdot \\ sin ( - d 1 x )\end{matrix} \} \cdot Adx} \vert \\ = \vert \frac{Yx}{Yx + \{ cos ( - d 1 x ) + j \cdot sin ( - d 1 x ) \} \cdot Adx} \vert\end{matrix} \qquad Formula 38$$

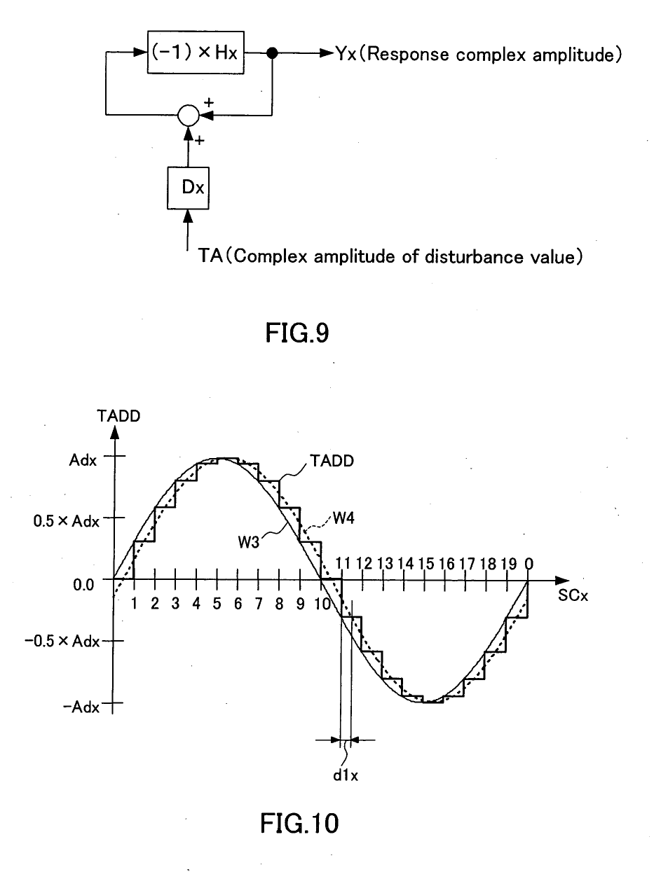

On the other hand, FIG. 9 shows a block diagram of the tracking servo system. From FIG. 9, the closed-loop characteristics of the tracking servo system, from the disturbance value TADD of the tracking servo system to the response Yx[SCx] of the tracking servo system, are expressed by Formula 39 below:

$$\frac{Yx}{TA} = Dx \cdot \frac{- Hx}{1 + Hx} \qquad Formula 39$$

In Formula 39, TA represents a disturbance complex amplitude value of the disturbance value TADD when the reference value table pointer SCx is SCx, Yx represents a response complex amplitude value of the response Yx[SCx] of the tracking servo system to the disturbance value TADD[SCx], Hx represents the open-loop transfer function of the tracking servo system, and Dx represents a transfer function of a substantial disturbance addition portion for the disturbance value TADD to the tracking servo system.

Based on Formula 29 described above, the disturbance complex amplitude value TA is Formula 40 below:
TA=Re(TA)+j·Im(TA)=Adx Formula 40

Furthermore, from Formulae 39 and 40, Formula 41 below can be obtained:

$$Hx = - \frac{Yx}{Yx + Dx \cdot Adx} \qquad Formula 41$$

When comparing Formula 38 to Formula 41, it is found that |Hx| is the gain of the open-loop transfer function of the tracking servo system at the measurement frequency fmx.

Lastly, the transfer function Dx of the addition portion will be described. FIG. 10 shows the state of output values of the disturbance value TADD. The vertical axis indicates the value of the disturbance value TADD, and the horizontal axis indicates the value of the reference value table pointer SCx. As shown in FIG. 10, the output values of the disturbance value TADD have a staircase pattern in which the value of the disturbance value TADD changes at every sampling timing (each time that the value of the reference value table pointer SCx changes). In FIG. 10, a waveform TADD is the waveform of the disturbance value TADD that is output sequentially (waveform of the first disturbance value group). That is to say, a sine wave value (in FIG. 10, sine wave values are shown by a waveform W3 (disturbance generating function)) is sampled at every sampling timing and forms a waveform to which zero-order holding is applied. The transfer function of a process in which such sampling and zero-order holding are performed is shown by Formula 42 below:

$$\begin{matrix}\frac{1 - exp ( - j \cdot 2 π \cdot \frac{fmx}{fsx} )}{j \cdot 2 π \cdot \frac{fmx}{fsx}} = \frac{1 - exp ( - j \cdot 2 π \cdot \frac{1}{Nx} )}{j \cdot 2 π \cdot \frac{fmx}{fsx}} \\ = exp ( - j \frac{2 π}{2 Nx} ) \frac{sin ( \frac{2 π}{2 Nx} )}{\frac{2 π}{2 Nx}}\end{matrix} \qquad Formula 42$$

In Formula 42, fmx represents the measurement frequency, fsx represents the sampling frequency, and Nx represents the division number.

From the foregoing, the transfer function Dx of the substantial addition portion for the first disturbance value group to the tracking servo system can be expressed by Formula 42 described above. That is to say, Formula 43 is obtained:

$$\begin{matrix}Dx = exp ( - j \frac{2 π}{2 Nx} ) \frac{sin ( \frac{2 π}{2 Nx} )}{\frac{2 π}{2 Nx}} \\ ≅ exp ( - j \frac{2 π}{2 Nx} ) \\ = cos ( - d 1 x ) + j \cdot sin ( - d 1 x )\end{matrix} \qquad Formula 43$$

Here, in the example given in Embodiment 4, the division number Nx of the first disturbance value group is set to 20, so that Formula 44 below holds:

$$\frac{sin ( \frac{2 π}{2 Nx} )}{\frac{2 π}{2 Nx}} = 0.996 \qquad Formula 44$$

A waveform W4 shown in FIG. 10 is a waveform having a phase that is delayed from the phase of the waveform W3 by 2π/Nx/2. Moreover, it is also seen from FIG. 10 that the waveform TADD (the first disturbance value group) has a phase delay of about 2π/Nx/2.

From the foregoing, it is found that the transfer function of the disturbance addition portion 1A is the transfer function Dx of the addition portion. Thus, it is found that the gain |Hx| of the tracking servo system at the measurement frequency fmx is as shown by Formula 33 described above. Furthermore, it is found that the amplification calculation gain kgx is corrected to a desired value by Formula 32, and that the gain of the tracking servo system can be adjusted precisely to 0 dB (unity) at the measurement frequency fmx.

In this manner, the gain of the tracking servo system can be adjusted precisely to 0 dB (unity) at the measurement frequency fmx because the phase of the correction complex amplitude value RUx in the gain modification process 412 is set as given by Formula 31. Moreover, it is also found from the description above that Formula 31 corresponds to the substantial phase in which the first disturbance value group that is constituted by the disturbance value TADD is added to the tracking servo system.

Moreover, in Embodiment 4, the phase of the correction complex amplitude value RUx in the gain modification process 412 is changed in accordance with the substantial phase of the disturbance value TADD for the tracking servo system, and thus, even when the division number Nx is reduced, the gain of the tracking servo system can be adjusted precisely to 0 dB (unity) at the measurement frequency fmx with accuracy.

Furthermore, since the measurement frequency fmx can be changed by changing the division number Nx, the gain of the tracking servo system can be adjusted to a desired value.

### EMBODIMENT 5

In Embodiment 5, another embodiment of the tracking control device of the present invention will be described. In Embodiment 5, the configuration is the same as that of Embodiment 4, except for the operation of the gain modification process (gain modification portion), and thus the description thereof will be omitted.

In the gain modification process according to Embodiment 5, a predetermined complex amplitude value RU2x is given by Formula 45 below:

$$RU 2 x = Re ( RU 2 x ) + j \cdot Im ( RU 2 x ) = \frac{Kx \cdot Nx \cdot Px}{2} \cdot Adx \qquad Formula 45$$

In Formula 45, Re(RU2x) represents the real part of the predetermined complex amplitude value RU2x, and Im(RU2x) represents the imaginary part of the predetermined complex amplitude value RU2x. Furthermore, Kx is the number of waves that are measured, Nx is the division number, Px is the reference value amplitude, and Adx is the amplitude of the first disturbance value group.

Furthermore, a correction complex value CUx is given by Formula 46 below:
CUx=cos(d2x)+j sin(d2x) Formula 46

Here, the phase of the predetermined complex amplitude value RU2x is 0, and the phase relative to the correction complex value CUx is d2x. This phase d2x is in antiphase (2π/2/Nx) with the phase −d1x in Embodiment 4 that is expressed by Formula 31 described above, and is substantially in antiphase with the phase of the first disturbance value group constituted by the disturbance value TADD with respect to the tracking servo system.

In the gain modification process, the amplification calculation gain kgx is corrected by Formula 47 below:

$$\begin{matrix}{kgx}^{′} = \frac{kgx}{\vert Hx \vert} \\ = \frac{kgx}{\vert \frac{( SUMRx + j \cdot SUMIx ) \cdot \{ cos ( d 2 x ) + j sin ( d 2 x ) \}}{\begin{matrix}( SUMRx + j \cdot SUMIx ) \cdot \\ \{ cos ( d 2 x ) + jsin ( d 2 x ) \} + \frac{Kx \cdot Nx \cdot Px}{2} \cdot Adx\end{matrix}} \vert}\end{matrix} \qquad Formula 47$$

That is to say, the amplification calculation gain kgx is corrected (changed to the value of the corrected amplification calculation gain kgx′) by determining the gain |Hx| of the tracking servo system at the measurement frequency fmx and multiplying the amplification calculation gain kgx by the inverse number of that gain. Thus, the gain of the tracking servo system can be adjusted precisely to 0 dB (unity) at the measurement frequency fmx.

When the gain |Hx| of the tracking servo system is extracted from Formula 47, Formula 48 below is obtained:

$$\vert Hx \vert = \vert \frac{( SUMRx + j \cdot SUMIx ) \cdot \{ cos ( d 2 x ) + jsin ( d 2 x ) \}}{( SUMRx + j \cdot SUMIx ) \cdot \{ cos ( d 2 x ) + jsin ( d 2 x ) \} + \frac{Kx \cdot Nx \cdot Px}{2} \cdot Adx} \vert \qquad Formula 48$$

From the foregoing, it is found that Formula 48 is equivalent to Formula 33 described above.

Therefore, in Embodiment 5, by correcting the detection complex amplitude value with the correction complex value CUx, the gain of the tracking servo system can be adjusted precisely to 0 dB (unity) at the measurement frequency fmx with accuracy even when the division number Nx is reduced.

Furthermore, in addition to the effects of Embodiment 4, Embodiment 5 is configured such that the predetermined complex amplitude value that is used in the gain modification process (operation of the gain modifier) is set to a real value (the phase is 0). Thus, the volume of information to be stored in advance is reduced.

### EMBODIMENT 6

In Embodiment 6, still another embodiment of the tracking control device according to the present invention will be described. In Embodiment 6, the configuration is the same as that of Embodiment 4, except for the gain modification process (operation of the gain modifier), and thus the description thereof will be omitted.

In Embodiments 4 and 5, no consideration is given to the phase shift that is dependent on the calculation time in the arithmetic unit 103A (see FIG. 6), but in Embodiment 6, the gain of the tracking servo system is adjusted even more accurately by giving consideration to the phase shift that is dependent on the calculation time. That is to say, the phase d2x in Formula 48 described above is replaced by a phase d3x that is expressed by Formula 49 below. The configuration and the operation of the gain modification process, other than this replacement, are the same as those of the gain modification process in Embodiments 4 and 5, and thus the description thereof will be omitted.

$$d 3 x = \frac{2 π}{2 \cdot Nx} + 2 π \cdot fmx \cdot Tdx \qquad Formula 49$$

In Formula 49, fmx represents the measurement frequency, Tdx represents a calculation time (calculation time of the arithmetic means) Tdx from the input operation of the error input portion 104A to the output operation of the drive output portion 106A. That is to say, the phase d3x of Formula 49 is the sum of 2π/Nx/2 and 2π×fmx×Tdx. The calculation time Tdx indicates the length of time by which the execution of the output operation of the drive output portion 106A is delayed from the input operation of the error input portion 104A. It should be noted that the present case corresponds to the case where the predetermined complex amplitude value (β) is Kx·Nx·Px·Adx/2·{cos(−2π×fmx×Tdx)+j sin(−2π×fmx×Tdx)} and the correction complex value (γ) is {cos(2π/Nx/2)+j sin(2π/Nx/2)}.

By configuring in this manner, the gain of the tracking servo system can be adjusted to 0 dB (unity) more precisely at the measurement frequency fmx even when the phase shift (−2π×fmx×Tdx) due to the calculation time Tdx increases significantly when compared to the phase d1x of Formula 31 described above. Hereinafter, this will be described in detail.

First, when the phase shift due to the calculation time Tdx is small enough to be negligible when compared to the phase that is expressed by Formula 31 described above, the value of Formula 31, which is the phase of the first disturbance value group that is used in Embodiments 4 and 5, is approximately equal to the value of Formula 49, and thus, it is found that the gain of the tracking servo system can be adjusted to 0 dB (unity) at the measurement frequency fmx.

Next, the case where the calculation time Tdx is significant when compared to the phase value that is expressed by Formula 31 described above will be described.

In this case, the phase shift that is dependent on the calculation time Tdx is added to the phase that is expressed by Formula 31 described above. The phase shift Tpx due to the calculation time Tdx with respect to the measurement frequency fmx of the gain of the tracking servo system is expressed by Formula 50 below:
TPx=2π·fmx·Tdx Formula 50
From the foregoing, Formula 49 can be obtained by adding Formula 50 and Formula 31.

In Embodiment 6, by the operation of the gain modification process, even when the calculation time Tdx is too long to ignore when compared to the phase that is expressed by Formula 31, consideration is given to its effect as shown in Formula 49 to calculate the amplification calculation gain kgx, and thus, the gain of the tracking servo system can be adjusted to 0 dB (unity) more precisely at the measurement frequency fmx.

In Embodiment 6, a value that is obtained by calculating in advance the phase part of the predetermined complex amplitude value (β) and the correction complex value (a value that is obtained by multiplying the denominator and the numerator of the complex gain Hx by a complex value that is conjugate with the predetermined complex amplitude value) is used to calculate the gain |Hx| of the tracking servo system. However, the gain can be calculated using other calculation methods, and the present invention is not limited to the calculation method in Embodiment 6.

Moreover, the phase compensation process is not limited to the process 414 in the phase compensator 2A shown in FIG. 7, and it is sufficient that an operation for compensating the phase of the tracking servo system is performed. The present invention includes the case where a phase compensator having a configuration that is different from the configuration of the phase compensator 2A shown in FIG. 7 is provided.

Moreover, in Embodiments 4 to 6, the disturbance value is output for every single sample. However, it is also possible to configure such that the disturbance value is output for every set of multiple samples, and such a modification is also included in the present invention.

Furthermore, various modifications are possible such as configuring the part that is configured as a digital circuit in Embodiments 4 to 6 as an analog circuit or configuring the part that is configured as an analog circuit as a digital circuit. Of course, the present invention includes such modifications.

As described above, according to Embodiments 4 to 6, the loop gain characteristics of the tracking control device can be adjusted accurately by the operation of the gain modifier 4A. In particular, even when the division number Nx is small, the loop gain characteristics of the tracking control device can be adjusted accurately. That is to say, in the gain modification process, the loop gain characteristics are adjusted accurately by setting the phase of the correction complex value in the gain modification process to a value according to the phase of the first disturbance value, and correcting the detection complex amplitude value or the predetermined complex amplitude value with the correction complex value.

In particular, there is a tendency for the division number Nx to be reduced progressively because the operating clock is reduced in order to increase the band of the tracking servo system and save electric power required for the arithmetic unit. Even in such a case, it is possible to adjust the loop gain characteristics accurately by using the tracking control device according to the present embodiment.

### INDUSTRIAL APPLICABILITY

The focus control device and the tracking control device of the present invention is useful as a focus control device and a tracking control device that are used in optical disk devices for recording and reproducing information on and from optical disks using laser beams such as from semiconductor lasers.

1. A focus control device comprising,
sensor means for receiving light reflected from an optical disk and outputting a plurality of sensor signals;
error signal synthesizing means for arithmetically synthesizing the plurality of sensor signals and generating a focus error signal;
arithmetic means comprising an error input portion for generating a focus error value group based on the focus error signal, a disturbance addition portion for adding a first disturbance value group that has periodicity to the focus error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the focus error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain;
driving means for outputting a driving current that is substantially proportional to the drive signal; and
a focus actuator for driving an objective lens according to the driving current,
wherein the gain modification portion modifies the amplification calculation gain based on the detection complex amplitude value, a predetermined complex amplitude value, and a correction complex value for correcting the predetermined complex amplitude value, and
wherein a phase of the correction complex value is substantially identical to a phase of the first disturbance value group in the disturbance addition portion.

2. The focus control device according to claim 1,
wherein when the detection complex amplitude value is α, the predetermined complex amplitude value is β, and the correction complex value is γ,
the gain modification portion modifies the amplification calculation gain based on the value of |α/(α+β×γ)|.

3. The focus control device according to claim 2,
wherein a numerical value group constituting a single cycle of the first disturbance value group is constituted by N disturbance values that are obtained by substantially equally dividing the time period of the single cycle,
wherein the phase of the correction complex value is substantially −2π/N/2, and
wherein a phase of the predetermined complex amplitude value is substantially 0.

4. The focus control device according to claim 2,
wherein the phase of the correction complex value is substantially −2π/N/2, and
wherein when a frequency of the first disturbance value group is fm and a processing time at the arithmetic means for generating the drive signal from the focus error signal is Td, a phase of the predetermined complex amplitude value is −2π×fm×Td.

5. A focus control device comprising,
sensor means for receiving light reflected from an optical disk and outputting a plurality of sensor signals;
error signal synthesizing means for arithmetically synthesizing the plurality of sensor signals and generating a focus error signal;
arithmetic means comprising an error input portion for generating a focus error value group based on the focus error signal, a disturbance addition portion for adding a first disturbance value group that has periodicity to the focus error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the focus error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain;
driving means for outputting a driving current that is approximately proportional to the drive signal; and
a focus actuator for driving an objective lens according to the driving current,
wherein the gain modification portion modifies the amplification calculation gain based on the detection complex amplitude value, a predetermined complex amplitude value, and a correction complex value for correcting the detection complex amplitude value, and
wherein a phase of the correction complex value is substantially identical to an antiphase of the first disturbance value group in the disturbance addition portion.

6. The focus control device according to claim 5,
wherein when the detection complex amplitude value is α, the predetermined complex amplitude value is β, and the correction complex value is γ,
the gain modification portion modifies the amplification calculation gain based on the value of |α×γ/(α×γ+β)|.

7. The focus control device according to claim 6,
wherein a numerical value group constituting a single cycle of the first disturbance value group is constituted by N disturbance values that are obtained by substantially equally dividing the time period of the single cycle,
wherein the phase of the correction complex value is substantially 2π/N/2, and
wherein a phase of the predetermined complex amplitude value is substantially 0.

8. The focus control device according to claim 6,
wherein the phase of the correction complex value is substantially 2π/N/2, and
wherein when a frequency of the first disturbance value group is fm and a processing time at the arithmetic means for generating the drive signal from the focus error signal is Td, a phase of the predetermined complex amplitude value is substantially −2π×fm×Td.

9. The focus control device according to claim 1,
wherein a numerical value group constituting a single cycle of the first disturbance value group is constituted by N disturbance values that are obtained by substantially equally dividing the time period of the single cycle, and
wherein the focus control device further comprises a storage portion for storing the N disturbance values.

10. The focus control device according to claim 1,
wherein the phase of the second disturbance value group is substantially identical to the phase of the first disturbance value group, and
wherein the phase of the third disturbance value group is shifted from the phase of the second disturbance value group substantially by π/2.

11. The focus control device according to claim 1,
wherein the response detection portion detects the detection complex amplitude value by referencing a plurality of focus error values that are input during a period of time that is an integral multiple of a cycle of the first disturbance value group.

12. The focus control device according to claim 1,
wherein a numerical value group constituting a single cycle of the first disturbance value group is constituted by disturbance values, the number of which is an integral multiple of 4, that are obtained by substantially equally dividing the time period of the single cycle.

13. A tracking control device comprising,
sensor means for receiving light reflected from an optical disk and outputting a plurality of sensor signals;
error signal synthesizing means for arithmetically synthesizing the plurality of sensor signals and generating a tracking error signal;
arithmetic means comprising an error input portion for generating a tracking error value group based on the tracking error signal, a disturbance addition portion for adding a first disturbance value group that has periodicity to the tracking error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the tracking error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain;
driving means for outputting a driving current that is substantially proportional to the drive signal; and
a tracking actuator for driving an objective lens according to the driving current,
wherein the gain modification portion modifies the amplification calculation gain based on the detection complex amplitude value, a predetermined complex amplitude value, and a correction complex value for correcting the predetermined complex amplitude value, and
wherein a phase of the correction complex value is substantially identical to a phase of the first disturbance value group in the disturbance addition portion.

14. The tracking control device according to claim 13,
wherein when the detection complex amplitude value is α, the predetermined complex amplitude value is β, and the correction complex value is γ,
the gain modification portion modifies the amplification calculation gain based on the value of |α/(α+β×γ)|.

15. The tracking control device according to claim 14,
wherein a numerical value group constituting a single cycle of the first disturbance value group is constituted by N disturbance values that are obtained by substantially equally dividing the time period of the single cycle,
wherein the phase of the correction complex value is substantially −2πN/2, and
wherein a phase of the predetermined complex amplitude value is substantially 0.

16. The tracking control device according to claim 14,
wherein the phase of the correction complex value is substantially −2π/N/2, and
wherein when a frequency of the first disturbance value group is fm and a processing time at the arithmetic means for generating the drive signal from the tracking error signal is Td, a phase of the predetermined complex amplitude value is −2π×fm×Td.

17. A tracking control device comprising,
sensor means for receiving light reflected from an optical disk and outputting a plurality of sensor signals;
error signal synthesizing means for arithmetically synthesizing the plurality of sensor signals and generating a tracking error signal;
arithmetic means comprising an error input portion for generating a tracking error value group based on the tracking error signal, a disturbance addition portion for adding a first disturbance value group that has periodicity to the tracking error value group that is generated by the error input portion and producing an output, a phase compensation portion for performing at least a phase compensation calculation and an amplification calculation according to an amplification calculation gain on the output of the disturbance addition portion and generating a drive value group, a drive output portion for generating a drive signal based on the drive value group, a response detection portion for detecting a detection complex amplitude value based on the tracking error value group that is generated by the error input portion, a second disturbance value group that has the same periodicity as the first disturbance value group, and a third disturbance value group that has the same periodicity as the second disturbance value group and a phase that is shifted from a phase of the second disturbance value group, and a gain modification portion for modifying the amplification calculation gain;
driving means for outputting a driving current that is approximately proportional to the drive signal; and
a tracking actuator for driving an objective lens according to the driving current,
wherein the gain modification portion modifies the amplification calculation gain based on the detection complex amplitude value, a predetermined complex amplitude value, and a correction complex value for correcting the detection complex amplitude value, and
wherein a phase of the correction complex value is substantially identical to an antiphase of the first disturbance value group in the disturbance addition portion.

18. The tracking control device according to claim 17,
wherein when the detection complex amplitude value is α, the predetermined complex amplitude value is β, and the correction complex value is γ,
the gain modification portion modifies the amplification calculation gain based on the value of |α×γ/(α×γ+β)|.

19. The tracking control device according to claim 18,
wherein a numerical value group constituting a single cycle of the first disturbance value group is constituted by N disturbance values that are obtained by substantially equally dividing the time period of the single cycle,
wherein the phase of the correction complex value is substantially 2π/N/2, and
wherein a phase of the predetermined complex amplitude value is substantially 0.

20. The tracking control device according to claim 18,
wherein the phase of the correction complex value is substantially 2π/N/2, and
wherein when a frequency of the first disturbance value group is fm and a processing time at the arithmetic means for generating the drive signal from the tracking error signal is Td, a phase of the predetermined complex amplitude value is substantially −2×fm×Td.

21. The tracking control device according to claim 13,
wherein a numerical value group constituting a single cycle of the first disturbance value group is constituted by N disturbance values that are obtained by substantially equally dividing the time period of the single cycle, and
wherein the tracking control device further comprises a storage portion for storing the N disturbance values.

22. The tracking control device according to claim 13,
wherein the phase of the second disturbance value group is substantially identical to the phase of the first disturbance value group, and
wherein the phase of the third disturbance value group is shifted from the phase of the second disturbance value group substantially by π/2.

23. The tracking control device according to claim 13,
wherein the response detection portion detects the detection complex amplitude value by referencing a plurality of tracking error values that are input during a period of time that is an integral multiple of a cycle of the first disturbance value group.

24. The tracking control device according to claim 13,
wherein a numerical value group constituting a single cycle of the first disturbance value group is constituted by disturbance values, the number of which is an integral multiple of 4, that are obtained by substantially equally dividing the time period of the single cycle.

25. The focus control device according to claim 5,
wherein a numerical value group constituting a single cycle of the first disturbance value group is constituted by N disturbance values that are obtained by substantially equally dividing the time period of the single cycle, and
wherein the focus control device further comprises a storage portion for storing the N disturbance values.

26. The focus control device according to claim 5,
wherein the phase of the second disturbance value group is substantially identical to the phase of the first disturbance value group, and
wherein the phase of the third disturbance value group is shifted from the phase of the second disturbance value group substantially by π/2.

27. The focus control device according to claim 5,
wherein the response detection portion detects the detection complex amplitude value by referencing a plurality of focus error values that are input during a period of time that is an integral multiple of a cycle of the first disturbance value group.

28. The focus control device according to claim 5,
wherein a numerical value group constituting a single cycle of the first disturbance value group is constituted by disturbance values, the number of which is an integral multiple of 4, that are obtained by substantially equally dividing the time period of the single cycle.

29. The tracking control device according to claim 17,
wherein a numerical value group constituting a single cycle of the first disturbance value group is constituted by N disturbance values that are obtained by substantially equally dividing the time period of the single cycle, and
wherein the tracking control device further comprises a storage portion for storing the N disturbance values.

30. The tracking control device according to claim 17,
wherein the phase of the second disturbance value group is substantially identical to the phase of the first disturbance value group, and
wherein the phase of the third disturbance value group is shifted from the phase of the second disturbance value group substantially by π/2.

31. The tracking control device according to claim 17,
wherein the response detection portion detects the detection complex amplitude value by referencing a plurality of tracking error values that are input during a period of time that is an integral multiple of a cycle of the first disturbance value group.

32. The tracking control device according to claim 17,
wherein a numerical value group constituting a single cycle of the first disturbance value group is constituted by disturbance values, the number of which is an integral multiple of 4, that are obtained by substantially equally dividing the time period of the single cycle.
